(19) United States
(12) Patent Application Publication
(10) Pub. No.: US 2002/0176430 A1
(43) Pub. Date: Nov. 28, 2002

(54) Buffer management for communication systems

(76) Inventors: Onkar S. Sangha, San Jose, CA (US); Ed Kwon, Fremont, CA (US); Vijay Maheshwari, Fremont, CA (US); Akihiro Kuichi, Saratoga, CA (US)

Correspondence Address: SKJERVEN, MORRILL, MACPHERSON LLP, 25 Metro Drive, Suite 700, San Jose, CA, 95110, US

(21) Appl. No.: 09/770,937

(22) Filed: Jan. 25, 2001

(51) Int. Cl. H04L 12/56

(52) U.S. Cl. 370/412; 370/395.7

(57) ABSTRACT

Methods and systems for managing data packets in various communication networks are provided. The system includes a first memory for storing at least a free data pointer and a buffer descriptor. The free data pointer points to a data buffer allocated in a second memory. The buffer descriptor includes at least a data pointer pointing to a data buffer configured to store one or a portion of the communication packet. The first memory has a maximum threshold such that if the number of buffer descriptors stored in the first memory reaches the maximum threshold one or more buffer descriptors stored in the first memory are transferred to the second memory.

### BACKGROUND

1. Field of Invention

The present invention relates to data communications and, more particularly, to a method and system for managing data buffers in a communication system to promote communication among multiple networks.

### COPYRIGHT AND TRADEMARK NOTICE

A portion of the disclosure of this patent document may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for the purpose of providing an enabling disclosure by way of example and shall not be construed to limit the scope of this invention to items or services associated with such marks.

### RELATED ART

With the advancement of digital and communication technology, large volumes of information are transferred to various destinations in communication networks. Communication networks are established and designed to promote the transfer and delivery of information to these various destinations in an efficient and reliable manner. Various communication networks transfer information based on different communication protocols. As such, systems and methods are developed to handle communication packets transmitted between multiple networks, such that information included in the packets assembled using one communication protocol can be recognized by the destination device or network that may communicate using a different communication protocol.

Switching communication packets received from a source and routing these packets to the destination requires the packets to be temporarily stored in a data storage management system. A buffer management system is typically used at the processing stage. A buffer manager, typically, manages communication packets by storing limited descriptor data associated with the packets in a fast data storage medium such as an on-chip memory, and storing the rest of the data associated with the packets in slower external memory. On-chip memory is storage medium integrated on data processing circuitry, while external memory is not, therefore data stored in on-chip memory can be accessed faster by the data processing unit on the data processing circuitry.

Due to high costs and overhead associated with manufacturing small size on-chip memory, the on-chip memory implemented in a buffer management system needs to be limited to a reasonable size. However, processing speed is dependent upon successfully storing and quickly accessing descriptor data from on-chip memory. When managing high traffic communications, communication packets may be dropped, due to the on-chip memory reaching a maximum capacity. As such, this size limitation may result in data loss and can substantially reduce the throughput of the buffer management system.

Thus, a system and method are needed that can address the size limitations associated with storage of descriptor data in on-chip memory.

### SUMMARY

In accordance with this invention, methods and systems for managing data packets in various communication networks are provided. Data packets assembled in one communication network can be destined for nodes in one or more other communication networks. During transmission, data packets may have to be segmented and reassembled before they reach their destination depending on communication protocols used at the sending and receiving network nodes. Communication systems (e.g., switches, routers, and gateways) are used to segment and/or reassemble communication packets in accordance with communication protocols of the various communication networks.

To reassemble or segment the packets, a communication system processes the data as it arrives. However, in many instances, the communication system may not be fast enough to process packets as quickly as they arrive. Therefore, the packets or information included in them are temporarily stored in a data storage medium until they are processed. In embodiments of the system, one or more data storage units, referred to as data buffers, are utilized to store communication packets or data associated with such packets. Data buffers are data storage locations allocated in memory.

Embodiments of the system are directed to managing data buffers such that communication packets stored in the buffers are efficiently processed, segmented, reassembled, and forwarded to appropriate network destinations. In one or more embodiments, the system includes one or more queues that are used to reference and store information associated with the communication packets. Each queue may be implemented either as on-chip memory or in external memory. In certain embodiments, the queues are implemented as a combination of the two. Due to the overhead associated with managing data transfer to and from external memory, storing and accessing data in on-chip memory is faster than storing or accessing data in external memory. Unfortunately, because on-chip memory is expensive to manufacture in comparison with external memory, to save costs, it is desirable to limit the size of on-chip memory to a minimum.

In a high traffic communication system, however, this size limitation may adversely effect the speed at which communication packets can be processed. As described in further detail below, one queue may be used for storing pointers (i.e., memory addresses) to a data buffer that includes a received communication packet, while another queue may be used for storing pointers to a data buffer that includes a communication packet ready to be transmitted to its destination. If a queue implemented in on-chip memory and used for storing received communication packets is full, then the system will not be able to receive any more packets until the information currently stored in the on-chip queue are processed. This inability to support newly arriving communication packets can lead to communication packets being dropped, and slow down the communication speed.

In accordance with one aspect of the system, to avoid transmission inefficiencies and data loss that may occur due to size limitations associated with on-chip queues, the content of the queues is transferred to external memory when the queues reach a maximum threshold level. In some embodiments, the content transferred to the external memory is then transferred back to the same on-chip queue or other on-chip queues included in the system when needed. The on-chip queues included in the system are: Read Free Queue (RFQ), Write Free Queue (WFQ), Receive Ready Queue (RRQ), and Transfer Ready Queue (TRQ).

RFQ is implemented to include free data pointers. Free data pointers are memory addresses that point to fixed-size empty data buffers allocated in external memory. When a packet is received, the I/O core requests a free data pointer from RFQ and stores the packet in the data buffer associated with that data pointer. The I/O core then constructs a buffer descriptor (BD) that contains header information associated with the communication packet but not the packet's payload. The constructed BD is truncated to minimize storage requirements and is stored in RRQ.

The CPU receives an interrupt to read RRQ when RRQ is not empty. CPU reads a BD and based on information stored therein determines whether a communication packet associated with the BD is to be transmitted to a different I/O port. Handling data packets through the associated BDs speeds up packet processing in that the CPU avoids the resource consuming process of accessing the external memory to retrieve needed data. All processing related data is included in BDs stored in RRQ implemented in on-chip memory.

If a communication packet is to be transferred to a different I/O port, the associated BD is transferred from RRQ to a TRQ associated with the destination port. In embodiments of the system, each I/O port is associated with a specific TRQ and WFQ. TRQ is implemented to store BDs that are to be transmitted via an I/O port. WFQ is implemented to store freed data pointers pointing to data buffers in external memory after the communication packets stored therein are processed and transmitted. Free data pointers stored in WFQ are returned to RFQ in due course as described below.

In embodiments of the system, data buffer queues have configurable minimum and maximum thresholds. These thresholds are used to monitor and maintain an optimal storage level in the queue. For example, when a maximum threshold is reached, data pointers or BDs stored in the queues are transferred to separate queues in external memory. When a minimum threshold is reached, data pointers or BDs stored in external memory, if any, are transferred to corresponding queues. For example, data pointers transferred to external memory from a WFQ associated with one I/O are returned to that I/O's RFQ. The expansion of data pointers and BDs to external memory allows the buffer manager to handle high traffic communication without substantially compromising processing speed or throughput.

In certain embodiments of the system, TRQs associated with different I/O ports are read based on one or more priority schemes to comply with quality of service requirements of I/O streams received on various ports. Other embodiments of the system are implemented to handle communication packets received via a single I/O port that includes interleaved streams. Interleaving is a communication scheme wherein a single communication stream includes packets of data that are generated from more than one source or packets of data that are destined for more than one destination.

An example of a communication protocol supporting such streams is the ATM protocol. Embodiments of the system support 32 ATM channel streams. The I/O core detects the channel associated with each received packet and constructs a BD that includes channel information. Since packets for different channels are interleaved in the same stream, the last packet associated with each channel includes a field identifying it as the last packet. Thus, a BD also includes information indicating whether a packet is the last packet received on a certain channel. The BD is stored in RRQ by the I/O core and the CPU is interrupted to read and process the BD.

One or more embodiments of the system include separate and distinct BD queues implemented in external memory that correspond to different ATM channels, for example. The CPU reads a BD from RRQ and during processing the BD examines the channel information included therein. The BD is then stored in the queue in external memory corresponding to the channel identified by the BD. The CPU also examines the BDs to determine whether the packet associated with the BD is the last packet in the communication stream received on a certain channel. When the CPU detects the last packet it notifies the driver associated with the application or port to which the ATM stream is directed. Thus, the data packets are delivered to the appropriate destination.

The invention is not limited to any particular embodiments described above. Rather, the embodiments provided herein are intended to be illustrative, but not limiting, of the scope of the invention.

### BRIEF DESCRIPTION OF THE DRAWINGS

FIG. 1 illustrates a communication system wherein voice and data are transmitted among multiple networks through a communication system, in accordance with one or more embodiments of the invention.

FIG. 2 illustrates a block diagram of the components of the communication system of FIG. 1, in accordance with one or more embodiments of the invention.

FIG. 3A illustrates a data pointer 310 associated with a data buffer in external memory, in accordance with one or more embodiments of the invention.

FIG. 3B illustrates a buffer descriptor associated with a communications packet, in accordance with one or more embodiments of the invention.

FIG. 4 illustrates an example of different configurations for the transmit ready queue implemented in accordance with one aspect of the invention.

FIG. 5 illustrates a block diagram of dual port memories that can be used in implementation of on-chip memory queues of the system of FIG. 1, in accordance with one or more embodiments of the system.

FIG. 6 illustrates a flow diagram of a method for receiving communication packets from one or more I/O ports, according to one or more embodiments of the system.

FIG. 7 illustrates a flow diagram of a method for processing received communication packets from an I/O port, in accordance with one aspect of the system.

FIGS. 8B and 8D through 8F illustrate flow diagrams of methods of transferring information between external memory and on-chip memory queues, in accordance with one or more embodiments of the invention.

FIG. 8C illustrates a flow diagram of a method of monitoring the integrity of received data, in accordance with one or more embodiments of the invention.

FIG. 9 illustrates a method for transmitting a communication packet to a designated destination, in accordance with one or more aspects of the system.

FIG. 10 is a block diagram illustrating separate expansion buffers allocated in external memory for each I/O port where data pointers are temporarily stored before the data pointers are transferred to the on-chip memory queue from which the data pointers were originated.

FIG. 11 illustrates a block diagram of a buffer management queue having a write FIFO and read FIFO, in accordance with one or more embodiments of the system.

FIG. 12 illustrates a block diagram of an on-chip queue, in accordance with one or more embodiments of the invention, for storing buffer descriptors associated with communication packets received as a part of an interleaved communication stream.

FIG. 13 illustrates a flow diagram of a method of sorting buffer descriptors into respective on-chip memory queues in external memory during processing and transferring communication packets to higher communication layers.

FIG. 14 illustrates a block diagram of the buffer manager of the system and the interface signals in accordance with one embodiment of the system.

### DETAILED DESCRIPTION

In the following detailed documentation, numerous specific details are set forth with respect to one or more embodiments of the invention. Of course, the invention may be practiced without some or all of these specific details or with variations in those details. In some instances, certain well known features have not been described in detail so as not to obscure other aspects of the invention.

SYSTEM ARCHITECTURE

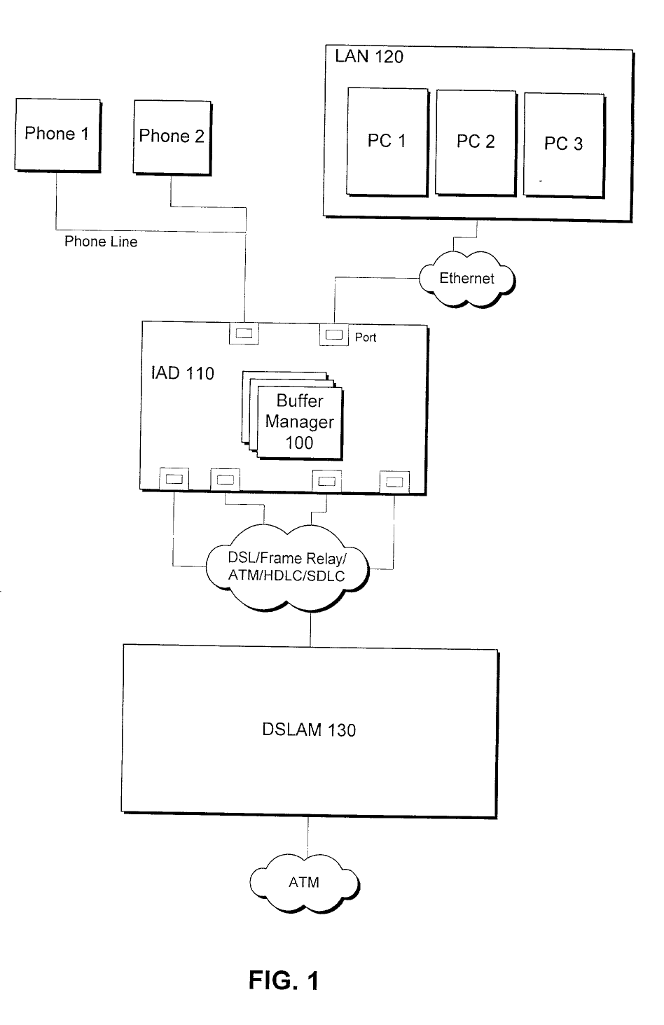

FIG. 1 illustrates a communication system wherein voice and data are transmitted among multiple networks through a communication system or Integrated Access Device (IAD) 110. IAD 110 multiplexes a variety of communication technologies onto one or more communication lines for transmission to a carrier (e.g., the local telephone company). As shown, in accordance with one or more embodiments of the system, IAD 110 promotes communication of voice and data between Local Area Network (LAN) 120, telephones 1 and 2, and DSL Access Multiplexor (DSLAM) 130. DSLAM 130 is a central office device that intermixes voice and Digital Subscriber Line (DSL) traffic in a Wide Area Network (WAN).

DSL is a communication technology that dramatically increases the digital capacity of ordinary telephone lines and allows for faster data communication. DSL technology is directed to two types of usage. Asymmetric DSL (ADSL) is for Internet access, where fast data download is required, but slow data upload is acceptable. Symmetric DSL (SDSL, HDSL, etc.) is designed for short haul connections that require high speed in both directions. In embodiments of the invention, communication between DSLAM 130 and IAD 110 is accomplished via the above-referenced communication methods or other well know communication methods, such as Frame Relay and Asynchronous Transfer Mode (ATM), for example.

Frame Relay is a high-speed packet switching protocol used in WANs. Frame relay provides permanent and switched logical connections, known as Permanent Virtual Circuits (PVCs) and Switched Virtual Circuits (SVCs). PVCs are logical connections provisioned ahead of time, while SVCs are provided on demand. The connections are identified by a Data Link Connection Identifier (DLCI) number. Every DLCI requires a Committed Information Rate (CIR) that defines a certain amount of transmission capacity for the connection. In contrast, ATM is a network protocol for both LANs and WANs that supports real-time voice and video as well as data. ATM uses switches that establish an end to end logical circuit. ATM guarantees a quality of service (QoS) for a transmission because it transmits all traffic in fixed-length packets that are easier to process in comparison with variable-length packets.

As illustrated in FIG. 1, various communication protocols (i.e., standards) can govern data communication in various segments of a network. IAD 110 includes one or more I/O ports to communicate with the various network segments. Information is grouped into communication packets in various formats based on the communication protocol used in each network segment. In embodiments of the system, IAD 110 is implemented so that it can be programmed to process communication packets received from various network segments and forward them to the designated destination in the proper format.

Processing a communication packet sometimes involves segmenting the packet into smaller portions and reassembling the smaller portion into newly formed packets, such that the new packet formats are recognizable by the destination device or network segment. This transition requires storing information contained in the packet and routing the information to an I/O port associated with the destination network segment. IAD 110 includes buffer manager 100 that receives, segments, and reassembles communication packets. Buffer manager 110 further prioritizes the storage and transfer of information contained in the packets in an efficient manner between various I/O ports. In certain embodiments of the system, each I/O port works in conjunction with a separate buffer manager.

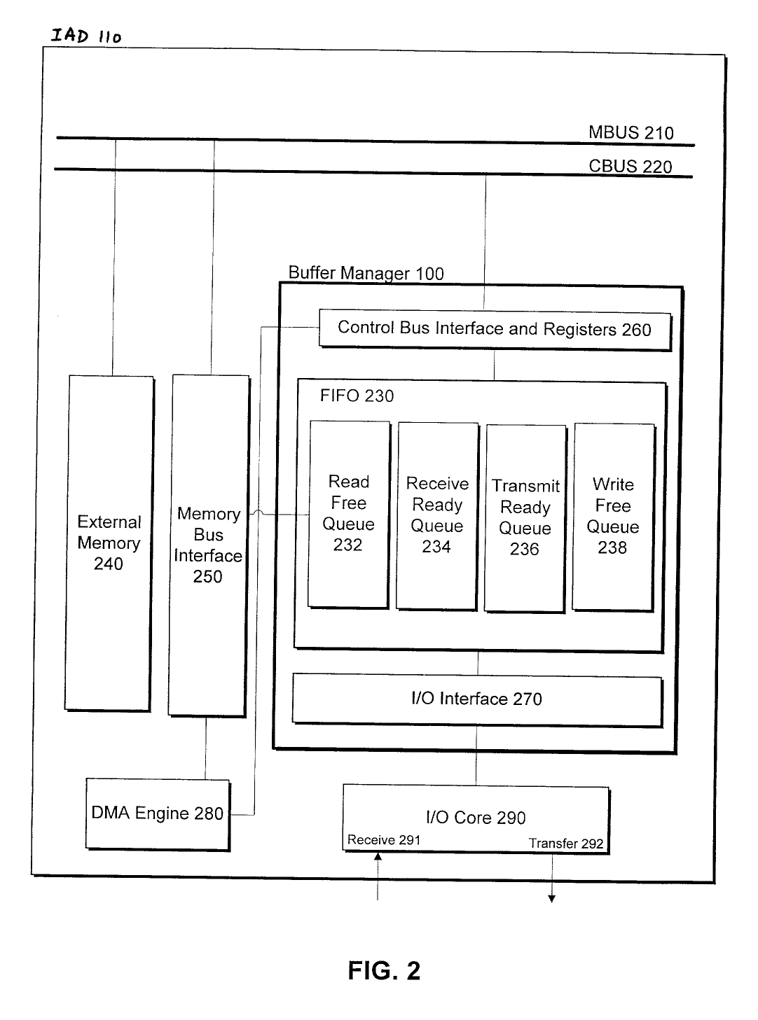

As illustrated in FIG. 2, IAD 110 includes memory bus (MBUS) 210, control bus (CBUS) 220, buffer manager 100, external memory 240, MBUS interface 250, Direct Memory Access (DMA) engine 280, and I/O core 290. I/O core 290 receives and transmits communication packets from receive and transfer lines 291 and 292, respectively.

Buffer manager 100 includes First In First Out (FIFO) queues 230, CBUS interface and registers 260, and Input/Output (I/O) interface 270. I/O core 290 communicates with buffer manager 100 via I/O interface 270. In certain embodiments of the system, the DMA engine 280 interfaces with buffer manager 100 and initiates data transfers between FIFO queues 230 and external memory 240 via MBUS 210. A central processing unit (CPU), not shown, communicates with FIFO 230 and DMA engine 280 via CBUS interface and registers 260 through CBUS 220. Embodiments of the invention may include more than one CPU. The CPU may be a RISC (Reduced Instruction Set Computer) based processor or other processor suitable for performing data communications related tasks.

The CPU examines a communication packet and makes the appropriate changes to memory tables and data structures to allow forwarding of packets in the appropriate format and to the designated destinations. In embodiments of the system, a communication packet is stored in a data structure called a data buffer. A data buffer is, typically, a pre-allocated range of addresses in external memory (e.g., dynamic RAM memory) reserved for storage of data. In some embodiments, data buffers are fixed in size and are set during configuration. For example, a 64 Kilobyte memory may be divided (i.e., partitioned) into 64 1024-byte data buffers or alternatively, 128 512-byte data buffers, depending on the type of communication packet being processed. A communication packet is stored in one or more data buffers, depending on the size of the packet and the data buffer. That is, if the size of a communication packet is greater than the buffer size, then more than one data buffer is consumed to store the packet.

In one or more embodiments, the system transfers communication packets among one or more I/O ports that communicate with different network segments. Different type of communication packets differ in length. Therefore, depending on the communication protocol used, in certain embodiments of the system, the size of the data buffers is programmable based on the type of communication protocol used. For example, in case of ATM I/O and Ethernet I/O, data buffers may be programmed to hold 512 bytes, or 2048 bytes respectively.

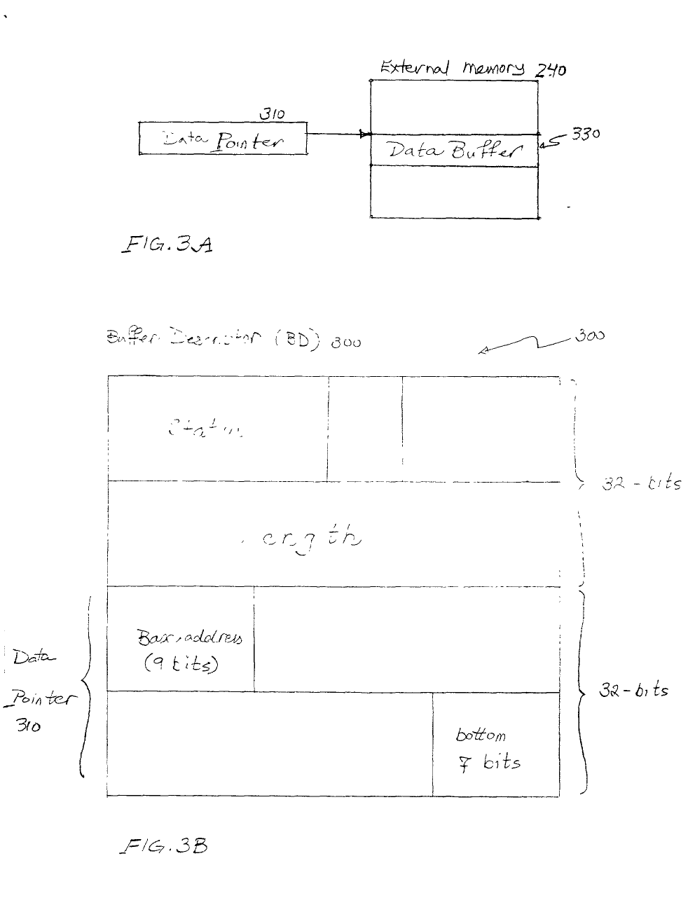

As communication packets are processed by the CPU, the packets may need to be copied or moved from one memory location (e.g., data buffer) to another. Moving data from one memory location to another involves deleting the original data and copying it to another memory location. Therefore, the speed at which communication packets are processed depends greatly on the CPU's processing speed and the speed at which data can be fetched from the data storage medium. Directly handling data stored in a data buffer is relatively slow because the data is stored in external memory. Thus, in embodiments of the system, communication packets are accessed indirectly in association with a data pointer. FIG. 3A illustrates a data pointer 310 associated with (i.e., pointing to) a data buffer 330 in external memory 240.

FIFO 230 includes a number of, preferably, on-chip memory queues that are used to store one or more data pointers 310 that point to one or more data buffers 330 in external memory 240. On-chip memory is an array of memory cells typically arranged in rows and columns and formed as a part of an integrated circuit. Each cell holds a value in the form of a digital bit. Information stored in on-chip memory can be accessed and processed at a faster rate in comparison to information stored in external memory because the CPU can avoid arbitration delays and overhead associated with accessing the information via a memory bus. Unfortunately, due to its relatively expensive cost, on-chip memory is not an economically viable medium for storage of large volumes of data. Referring to FIG. 3B, to increase data access bandwidth, communication packets are handled indirectly by means of buffer descriptors (BDs) 300. BDs 300 are transferable to external memory in accordance with one or more embodiments of the system.

A BD 300 is a data structure that contains information about certain characteristics of a communication packet (e.g., size, type, destination) so that buffer manager 100 can handle the packet. BD 300 at least includes a data pointer 310 to data buffer 330. However, BD 300 does not include data stored in the communication packet's payload. Payload, typically, refers to a part of a communication packet that holds the message data in contrast to the headers that provide control information about the communication packet. For example, BD 300 contains information about a communication packet to adequately identify and describe the packet's length, destination, and memory storage location needed for completion of the communication.

The system handles a variable length communication packet by associating it with a fixed size BD that is much smaller than the length of the entire packet. For example, in accordance with one aspect of the invention, BD 300 can be 64 bits (or 8 bytes) long, where a communication packet can be up to 64K bytes in size. Handling (e.g., accessing, retrieving, moving and copying) a 64-bit BD stored in on-chip memory is considerably faster than handling an entire communication packet stored in a data buffer 330 in external memory 240.

In one or more embodiments of the system, BD 300 includes information about a packet's status, length, and storage location in memory. The storage location in external memory is represented by a data pointer 310. Data pointer 310 points to a memory address in external memory 240 where data buffer 330 containing the communication packet begins. Data pointer 310 in certain embodiments of the invention is a 32-bit pointer, for example. FIG. 3B illustrates an exemplary BD 300 that contains a 32-bit data pointer 310, in addition to the other fields.

The status field is used to report the results of a Cyclical Redundancy Check (CRC) after the communication packet is received. CRC is an error checking technique used to ensure the accuracy of transmitted and received digital data. In embodiments of the invention, for example, the transmitted data in predetermined lengths is divided by a fixed divisor. The remainder, if any, of the calculation is appended onto and sent with the data. At the receiving end, the remainder value for the received data is recalculated based on using the same divisor. If the newly calculated remainder value does not match the transmitted remainder, an error is detected that indicates data was corrupted during transmission.

The length field indicates the length of the communication packet. Certain embodiments of the invention may include fields in addition or in exclusion to the fields mentioned above. For example, in some embodiments, BD 300 may include a 5-bit hashing field for faster table lookup searches of destination addresses. In some embodiments, a 2-bit type field, for example, may be included to indicate a BD location (e.g., first, middle, last) in the chain of BDs constructed for a packet. Depending on the length of the packet, there may be one or more BDs constructed for a packet. A destination field, for example, may indicate the destination port or ports to which the packet is to be transmitted during bridging or switching. An identifier field, for example, may be used to indicate the I/O port (e.g., Ethernet or USB port) from which a BD originates. Tables 1 and 2 provide examples of buffer descriptors for two different communication protocols in accordance with one or more embodiments of the invention. Other formats and fields may be included.

TABLE 1
Exemplary Buffer Descriptor for an ATM packet

| | | | | | | | | | | | | |
|---|---|---|---|---|---|---|---|---|---|---|---|---|
| 15 | 14 | 13 | 12 | 11 | 10 | 9 | 8 | 7 | 6 | 5 4 | 3 2 | 1 0 |

| | | | |
|---|---|---|---|
| Virtual circuit | Status | Identifier | Type |

channel number

Length

| | |
|---|---|
| Data Pointer | Data Pointer |
| Data Pointer | Data Pointer |

TABLE 2
Exemplary Buffer Descriptor for an Ethernet packet

| | | | | | | | | | | | | |
|---|---|---|---|---|---|---|---|---|---|---|---|---|
| 15 | 14 | 13 | 12 | 11 | 10 | 9 | 8 | 7 | 6 | 5 4 | 3 2 | 1 0 |

| | | | | |
|---|---|---|---|---|
| Destination Address | Status and control | B A | Identifier | Type |

| | |
|---|---|
| Hash | |
| Source Address Hash | Length |
| Data Pointer | Data Pointer |
| Data Pointer | Data Pointer |

Table 3 is an example of bit combinations that can be used to indicate a packet type, in accordance with one or more embodiments of the invention. If a communication packet is larger than the size of the data buffer then the information contained in the communication packet is stored in more than one data buffer. The type information is included in the BD to indicate whether a data buffer is the first, middle, or last in the chain of data buffers.

TABLE 3
Exemplary BD Type Definition

| Bit 1 | Bit 2 | Type |
|---|---|---|
| 0 | 0 | Entire communication packet stored in single BD |
| 0 | 1 | First in chain |
| 1 | 0 | Middle of chain |
| 1 | 1 | Last in chain |

Referring back to FIG. 2, in accordance with one aspect of the invention, FIFO 230 includes one or more of the following queues: Read Free Queue (RFQ) 232, Receive Ready Queue (RRQ) 234, Transmit Ready Queue (TRQ) 236, and Write Free Queue (WFQ) 238. RFQ 232 and WFQ 238 are used to store one or more data pointers 310. RRQ 234 and TRQ 236 are used to store one or more data buffers 330. The above FIFO queues may be implemented on-chip or in external memory. However, in embodiments of the system for optimum performance, all buffer management queues in FIFO 230, with the exception of the data buffers, reside in on-chip memory (e.g., hardware). Table 4 provides an example of the depth and size that can be assigned to each queue, in accordance with one aspect of the invention. To meet QoS requirements, certain embodiments of the system include four TRQ 236s, for example, as further described below.

TABLE 4
Size of On-Chip Memory for FIFO Queues

| Queue | Depth | Size in bytes |
|---|---|---|
| RFQ | 128 | 128 × 2 = 256 |
| RRQ | 128 | 128 × 5 = 640 |
| TRQ | 32 | 32 × 5 = 160 |
| WFQ | 32 | 32 × 2 = 64 |

Read Free Queue

RFQ 232 includes a list of free (i.e., empty) data pointers that point to data buffers in external memory. When a communication packet is received, I/O core 290 interacts with I/O interface 270 to read an available data pointer from RFQ 232. An available data pointer is a data pointer that points to an empty storage location allocated in external memory called a data buffer. Some or all the information in the received communication packet is stored in one or more data buffers to which the read data pointer points. Similarly, after a communication packet is assembled by the CPU and is ready for transmission, the CPU interacts with CBUS interface and registers 260 to read an available data pointer from RFQ 232. Some or all of the information in the assembled communication packet is stored in a data buffer to which the read data pointer points, until such time that the communication packet can be transmitted.

In accordance with one aspect of the invention, once information stored in a data buffer is transmitted, the data pointer pointing to that data buffer is said to be freed. At that point, I/O core 290 writes the freed data pointer to WFQ. When the number of freed data pointers stored in WFQ 238 reaches a maximum threshold, the buffer manager's control program asserts an interrupt to the CPU. The control program can be implemented in form of firmware or software, in accordance with one or more embodiments of the system. The CPU sends a DMA command through CBUS interface and registers 260 to transfer freed data pointers from WFQ 238 to external memory 240 via MBUS 210. When the number of freed data pointers stored in RFQ 232 reaches a minimum threshold, the buffer manager control program asserts an interrupt to the CPU. The CPU sends a DMA command through CBUS interface and registers 260 to transfer freed data pointers from external memory to RFQ 232 via MBUS 210.

Referring to FIGS. 3A and 3B, in accordance with one aspect of the invention, the control program assigns 32-bit data pointers to point to data buffers allocated in external memory at the time of configuration. To save in design and manufacturing costs, however, data pointers are truncated and stored in RFQ 232 with fewer number of bits. The truncation is performed based on the size of data buffers and the manner of allocation of data buffers in the external memory, as described below by way of example.

To illustrate, consider an 8 Megabyte memory space that is represented by a 32-bit memory address. In accordance with one aspect of the system, an 8-Megabyte memory space is partitioned into 8000 1024-byte data buffers. Since the memory space is 8 Megabytes, a 23-bit data pointer is sufficiently large to address the memory space. In accordance with one aspect of the system, the data buffers are aligned on 128-byte address boundaries. As a result, the 7 least significant bits of a 32-bit data pointer can be set to zero, for example, because they are not significant for memory addressing purposes.

The most 9 significant bits of the 32-bit data pointer define the particular 8- Megabyte memory space and thus are common to all data pointers. In accordance with one embodiment of the system, the most significant 9 bits can be stored in a base register, allowing a 32-bit data pointer to be stored in a 16-bit data buffer. Other implementations and truncation schemes are possible. As such the above description should not be construed to limit the scope of the invention to the provided example. Table 5 illustrates the format of an exemplary data pointer address, in accordance with one or more embodiments of the invention.

TABLE 5
Exemplary 32 bit Data Pointer Address

| | | |
|---|---|---|
| 9 most significant bits | 16 bits stored in Queue | 7 least significant bits |
| stored in base register | | |

Receive Ready Queue

RRQ 234 contains a list of ready (filled) BDs 300 that are constructed and associated with communication packets received by the system, as discussed earlier. A ready BD 300 includes a data pointer and other necessary information to reference a data buffer in external memory that stores one or part of a received communication packet. In accordance with one or more embodiments of the system, I/O core 290 queues ready BDs 300 to RRQ 234 by interacting with I/O interface 270. The CPU reads ready BDs 300 from RRQ 234 by interacting with CBUS interface and registers 260.

In certain embodiments of the system, BD 300 is 64 bits but is truncated to 46 bits when it is stored in RRQ 234 for processing efficiency. This is accomplished by truncating the 32-bit data pointer into a 16-bit data pointer as described above. The status bits can be truncated from 4 bits to 2 bits, because only 2 bits of the status field are used, as it is described in further detail below.

Transmit Ready Queue

TRQ 236 contains a list of ready (filled) BDs 300 that have been processed by the CPU and are associated with communication packets that can be transmitted to a destination. The CPU queues ready BDs to TRQ 236 and I/O core 290 reads from TRQ 236. One or more embodiments of the invention include more than one (e.g., four) TRQ 236s (not shown) in order to meet QoS requirements for timely delivery of various types of data. By assigning priority values to multiple TRQ 236s, various types of data (e.g., voice, high priority data, network management data) can be transmitted based on predetermined priorities programmed into the system. For example, voice packets can be routed through a first queue with the highest assigned priority, while other data can be routed through second, third, and forth queues with lower priorities.

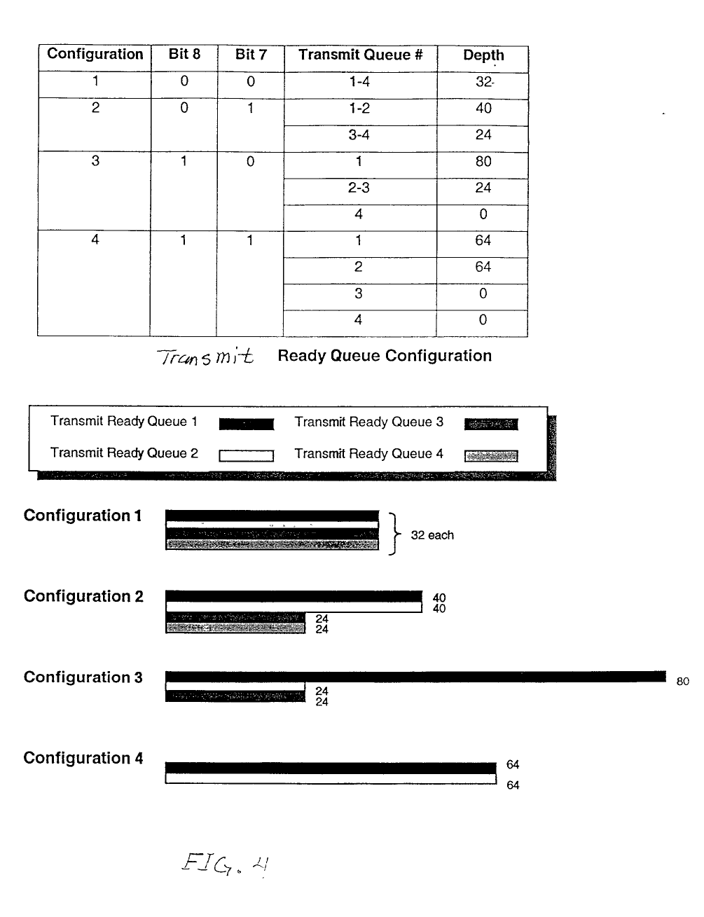

For optimal performance the size of each TRQ 236 can be configured to one or more fixed configurations, when the system is initially configured. FIG. 4 illustrates an example of different configurations implemented in accordance with one aspect of the invention. For example, in one configuration (e.g., bits 7 and 8 being 00), each of the four queues are configured to be 32 BDs deep. In another configuration (e.g., bits 7 and 8 being 01), first and second queues are 40 BDs deep each, and third and forth queues are 24 BDs deep each. In the latter configuration, for example, the first two queues are used to handle higher priority traffic over the last two queues. As illustrated in FIG. 4 other configurations are also possible.

It should be noted that the configurations described here and illustrated in FIG. 4 are provided by way of example. The system is programmable to support various configurations depending on the type of communication packets processed. Further, different transmission priority algorithms may be used. For example, in configuration “00” a round robin approach may be used to transmit one packet from each queue at a time. In configuration “01”, for example, the 24-bit queues may have priority over the 40-bit queues as long as the 24-bit queues are full. Other algorithms are possible.

The priority algorithms used for the TRQ 236s can be specific to each type of I/O to which buffer manager 100 is connected. For example, the Ethernet I/O core can read from the TRQ 236s according to one set of rules, while the CPU can read from the TRQs according to another set of rules. In certain cases, buffer manager 100 is implemented so that the priorities of each TRQ 236 are dynamically configurable.

Write Free Queue

WFQ 238 contains a list of free (empty) data pointers 310 returned by I/O core 290 and the CPU. DMA engine 280 reads from data pointers 310 from WFQ 238 to external memory 320. In embodiments of the system, RFQ 232 and WFQ 238 are combined in a 128×32 bit dual port memory, for example. A dual port memory allows for information to be written and read to and from memory simultaneously between the CPU, I/O core 290, and DMA engine 280.

It is noteworthy that RFQ 232 and WFQ 238 may be physically implemented in a single on-chip memory architecture that is logically divided into two separate queues. In a certain embodiment of the invention, the queues are implemented so that RFQ 232 can be only read from, and WFQ 238 can be only written to by the CPU or I/O core 290. Further, RRQ 234 and TRQ 236 may be also combined in a 256×46 dual port memory.

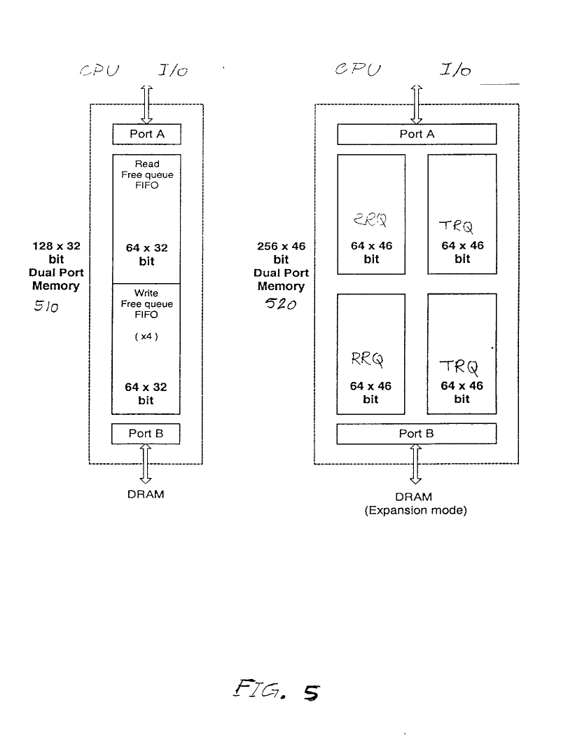

FIG. 5 illustrates a block diagram of dual port memories 510 and 520 each having a Port A and a Port B, in accordance with one or more embodiments of the system. Port A is in communication with the CPU and I/O core 290 via CBUS interface and registers 260 and I/O interface 290. Port B is in communication with external memory 240 via MBUS interface 250 (FIG. 2). CBUS interface and registers 260 includes one or more registers for temporarily storing data that are to be read from or written to FIFO queues 230.

Using this scheme, request for accessing data buffers in external memory is granted immediately and the content of FIFO queues 230 is updated later, accordingly. A review of Appendices A and B provides a better understanding of the specifications of registers included in interfaces 250, 260 and 270 and the signals implemented, in accordance with one or more embodiments of the system. The registers provide an interface between the CPU, buffer manager 100, external memory 240, DMA engine 280, and I/O core 290. Appendices A and B are attached hereto and incorporated by reference in their entirety in this disclosure.

SYSTEM SOFTWARE OR FIRMWARE

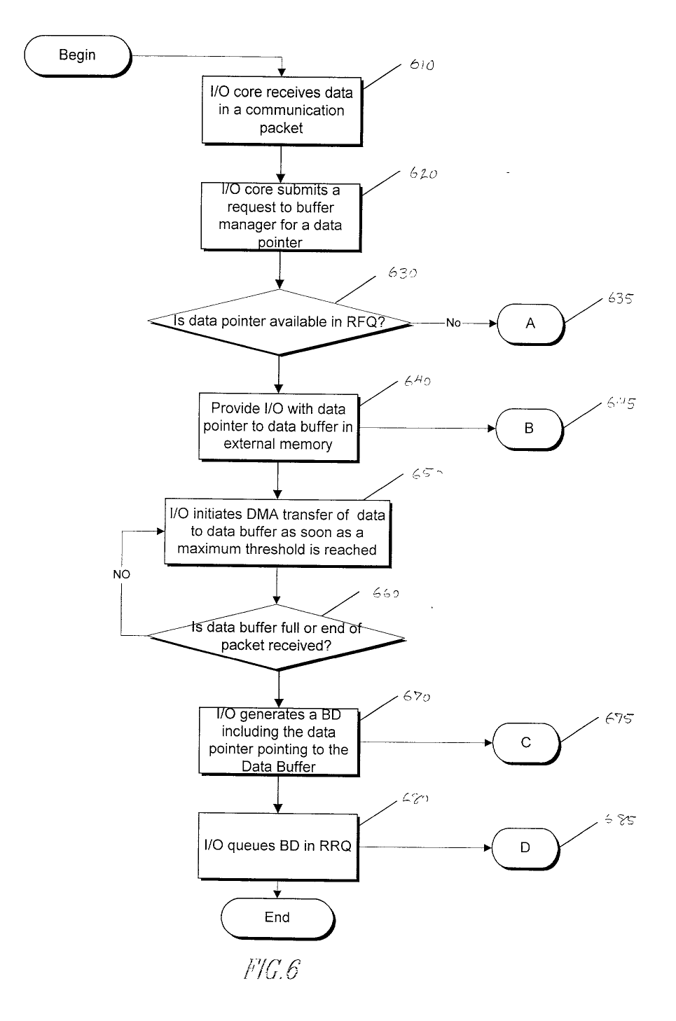

In embodiments of the invention, a control program in form of software or firmware is stored in system memory and is executed by one or more CPUs to control the tasks of receiving, processing, and transferring communication packets to and from one or more I/O ports. FIGS. 6 through 9 illustrate flow diagrams of methods of handling communication packets forwarded to buffer manager 100. These methods can be implemented in the form of control hardware and/or control software, according to one or more embodiments of the system, as further described below.

Receive Method

FIG. 6 illustrates a flow diagram of a method for receiving communication packets from one or more I/O ports, according to one or more embodiments of the system. At step 610, I/O core 290 receives a communication packet via receive line 291. I/O core 290 communicates with buffer manager 100's FIFO 230, via I/O interface 270. At step 620, I/O core 290 submits a request to buffer manager 100 to receive a free data pointer. A free data pointer points to a memory address in external memory and indicates the beginning of a data buffer (see FIG. 3A). At step 630, the control program determines if a free data pointer is available in RFQ 232. RFQ 232 is an on-chip memory that includes data pointers to free data buffers in external memory. In some embodiments, RFQ 232 after the system configuration includes 128 free data pointers, for example. If no free data pointers are available in RFQ 232, then the system handles an error at step 635. In embodiments of the system, if an error is encountered the received communication packet will be dropped.

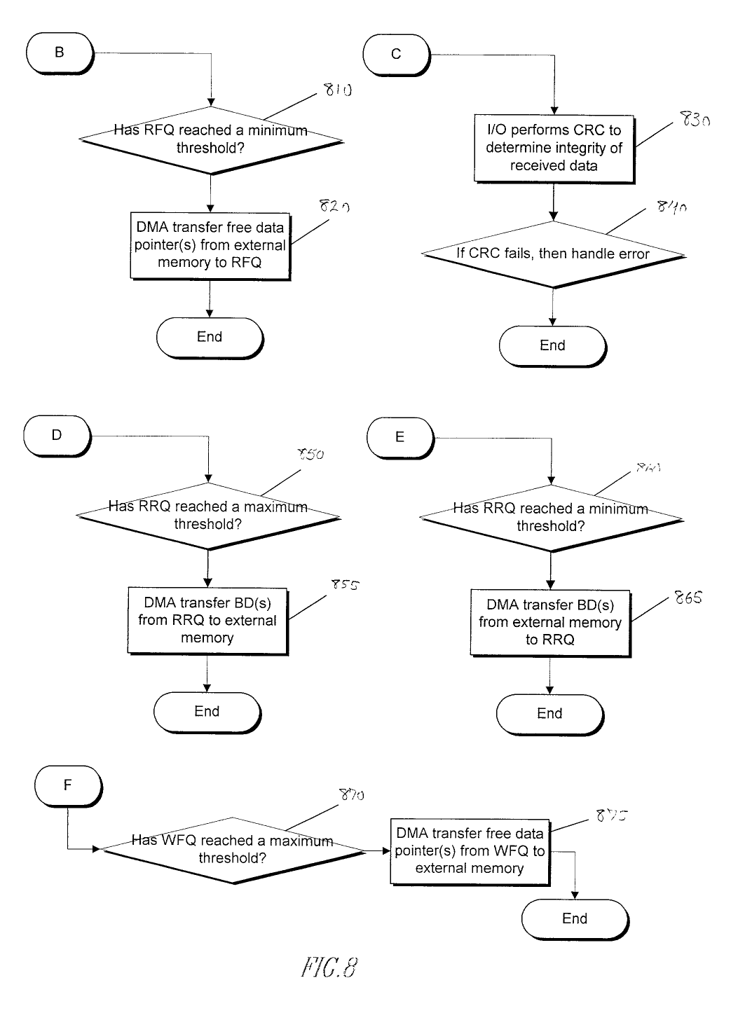

If a free data pointer is available, then at step 640 the control program provides I/O core 290 with a free data pointer to a data buffer in external memory. In certain embodiments of the system, at step 645, the control program monitors the availability of free data pointers in RFQ 232 after a data pointer has been read. Referring to FIG. 8, at step 810, the control program determines if RFQ 232 has reached a minimum threshold. If so, then at step 820 the control program asserts an interrupt to the CPU and the CPU sends a DMA command through CBUS interface and registers 260 to transfer freed data pointers from external memory to RFQ 232 via MBUS 210.

Referring back to FIG. 6, once I/O core 290 (shown in FIG. 2) receives a free data pointer, at step 650, I/O core 290 initiates a DMA transfer of data to the data buffer pointed to by the free pointer. In embodiments of the invention, I/O core 290 includes a data queue with a configurable threshold. Once the data queue has reached a threshold (e.g., 64 bytes), a DMA transfer of data from the data queue to the data buffer in the external memory is initiated.

At step 660, I/O core 290 monitors the data buffer where the data is stored. If the control program detects that the data buffer is full or if an end of packet is detected, then at step 670 I/O core 290 generates a BD and includes in the BD the data pointer that points to the data buffer. As illustrated in FIG. 3B, in addition to the data pointer, other fields are also included in the BD for example to indicate the status, type, and length of information stored.

In certain embodiments, depending on the type of I/O packet (e.g., Ethernet, USB, HDLC, or WAN, etc.) at step 675 the control program performs an integrity check on the data stored to ensure that the data received in a communication packet is intact. Referring to FIG. 8, at step 830, I/O core 290 performs a CRC on the data to determine data integrity. If an error is detected then at step 840 the control program handles the error by, for example, including an error code in the BD's status field.

After I/O core 290 has constructed a BD for the received packet, I/O core 290 queues the BD in RRQ 234, at step 680. In certain embodiments of the system, at step 685 the control program monitors RRQ 234's capacity threshold. Referring to FIG. 8, at step 850, the control program determines whether RRQ 234 has reached a maximum threshold. If so, at step 855 the control program DMA transfers one or more BDs from RRQ 234 to external memory. This process allows for the system to expand the storage of BDs from on-chip memory, in this case RRQ 234, to external memory. This expansion scheme is described in further detail below.

Processing Method

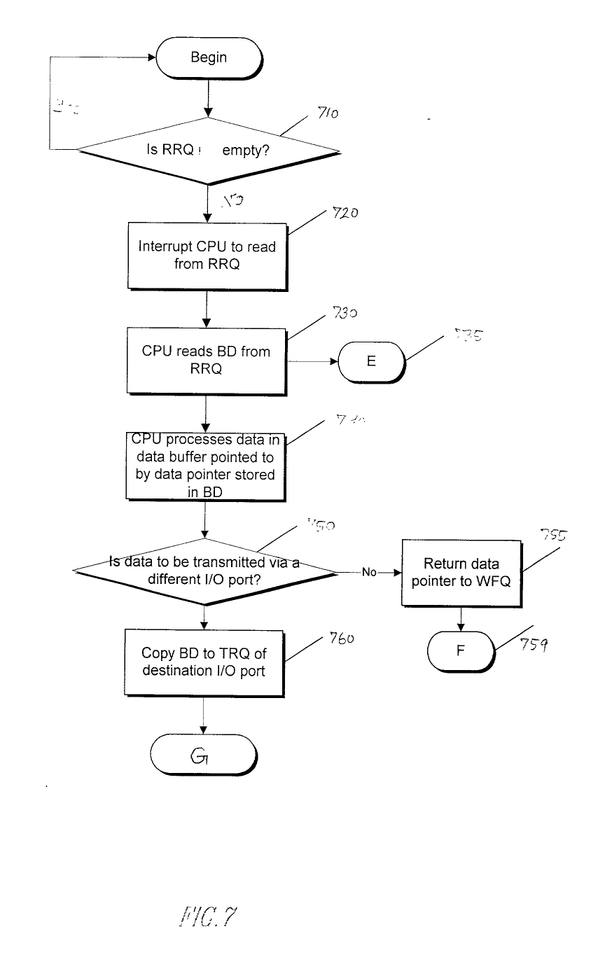

FIG. 7 illustrates a flow diagram of a method for processing received communication packets. In accordance with one aspect of the system, at step 710, I/O core 290 examines RRQ 234 to determine if it is empty. If RRQ 234 is not empty (i.e., includes a BD), at step 720, I/O core 290 generates an interrupt signal to the CPU to read one or more BDs from RRQ 234. At step 730, the CPU reads one or more BDs from RRQ 234.

In certain embodiments of the system after the CPU reads from RRQ 234, at step 735, the control program examines RRQ 234's storage level to determine if it is above or below a minimum threshold level. For optimal performance and to avoid delays associated with retrieving data from external memory, it is desirable to maintain a minimum number of buffer descriptors stored in each on-chip queues. Referring to FIG. 8, at step 860, the control program determines if RRQ 234 has reached the minimum threshold. If so, then at step 865 the control program causes one or more BDs to be DMA transferred from the external memory to RRQ 234.

It should be noted that the DMA transfer can take place only if one or more BDs are transferred to the external memory as described in step 855. Transferring BDs from external memory to RRQ 234 when the minimum threshold is reached prevents RRQ 234 from reaching a close to empty status. If RRQ 234 is empty then the CPU will have to access BDs stored in external memory or wait for BDs to be transferred from external memory to RRQ 234 before the CPU can process the BDs. In accordance with an aspect of the invention, by monitoring and maintaining a minimum threshold level, more BDs are transferred to RRQ 234 before RRQ 234 reaches an empty status. As a result, the CPU can quickly access BDs stored in RRQ 234 and does not have to access the external memory or wait for the BDs to be transferred from the external memory.

Referring back to FIG. 7, after the CPU reads a BD from RRQ 234, the CPU then at step 740 processes information stored in the BD and/or information stored in the data buffer pointed to by the data pointer stored in the BD. In certain embodiments, the CPU examines the BD's status bits (i.e., the bits in the status field) for indication of any errors in transmission. If an error is detected then the communication packet is dropped by returning the data pointer to WFQ 238.

Other fields in the BD designate the destination and the format in which the information is to be transferred. If no errors are detected, at step 750, the CPU analyzes the destination address to determine if the packet is to be transmitted to a different I/O port than it was received. If the information does not need to be retransmitted, then no action needs to be taken and at step 755 the data pointer associate with the packet is returned to WFQ 238. As described above, one or more TRQ 236's may be implemented, in accordance with one or more embodiments, to satisfy QoS requirements so that transmission of various I/O packets can be prioritized.

In certain embodiments of the system, the control program at step 759 examines WFQ 238 for maximum threshold level. Referring to FIG. 8, at step 870, the control program determines if WFQ 238 has reached a maximum threshold after the data pointer is returned to WFQ 238, at step 755. If so, then at step 875, the control software DMA transfers one or more data pointers from WFQ 238 to the external memory.

In absence of a maximum threshold monitoring scheme, the control software will have to be implemented to DMA transfer each data pointer to external memory every time it is stored in WFQ 238. Frequent DMA transfers between on-chip and external memory are resource intensive. By monitoring a maximum threshold level, a plurality of data pointers may be transferred together rather than individually and via multiple DMA transfers, thereby saving valuable system resources.

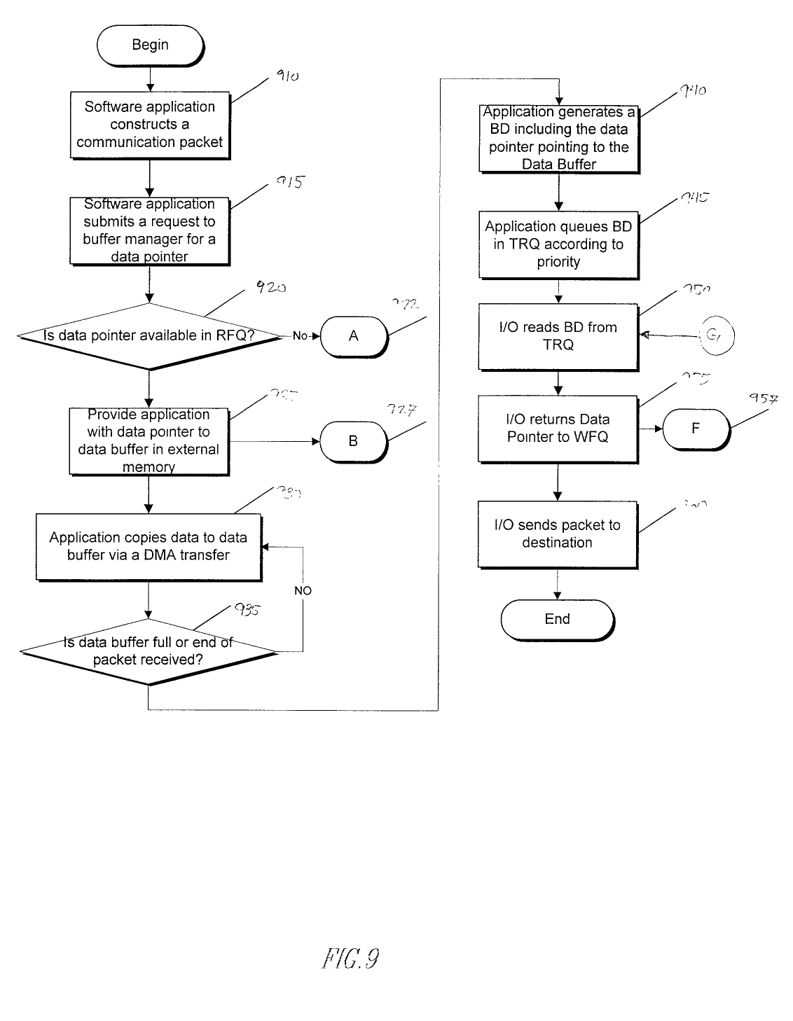

Referring back to FIG. 7, if at step 750, the control program determines that the received packet is to be transmitted via a different I/O port, then at step 760 the control program copies the BD associated with the packet to TRQ 236 (FIG. 2) associated with the destination I/O port. Once the BD is queued into TRQ 236, I/O core 290 is interrupted to poll TRQ 236. Referring to FIG. 9, as it is described in further detail below, at steps 950 through 960, core 290 (FIG. 2) reads a BD from TRQ 236 and returns the data pointer associated with the BD to WFQ 238 when the packet is forwarded to a network destination.

In embodiments of the invention, each I/O port may be connected to a separate buffer manager. Therefore, it is noteworthy that in accordance with one or more aspects of the system, data packets can be handled indirectly by copying the BD associated with the packet from a RRQ 234 in a first buffer manager to a TRQ 236 of a second buffer manager, as further described below.

Each buffer manager is programmable so that it can directly transfer a BD from one on-chip queue (e.g., RRQ 234) to another (e.g., TRQ 236) without having to copy the entire content of a data buffer from one memory location to another. Thus, the switching of a packet from one I/O port to another port can be accomplished in a highly efficient manner.

In a network environment, the communication protocol that contains the physical address of a client or server station is referred to as Layer 2, the “data link layer,” or the “Media Access Control (MAC) layer. In this layer, the destination address stored in a BD for a communication packet is inspected by a communication controller (e.g., a bridge or switch) for data routing purposes. The CPU determines if the communication packet being processed at step 740 is destined for the upper layers of the networking stack. If so, I/O core 290 sends the packet associated with the BD to its destination by copying the data pointer in the BD to data buffers maintained by the networking stack software (e.g., MBUF).

For example, if a BD is received on a first Ethernet Port is to be forwarded to a second Ethernet Port, after the packet has been transmitted to the second Ethernet Port, I/O core 290 associated with the second Ethernet Port returns the data pointer to WFQ 238 associated with the first Ethernet Port. As it is further described below, this scheme ensures that data pointers are not lost between different buffer managers, so that the initial balance of data pointers assigned to each buffer manager at the time of initial configuration is maintained.

Transmit Method

FIG. 9 illustrates a method for transmitting a communication packet to a designated destination, in accordance with one or more aspects of the system. At step 910, a software application constructs a communication packet for transmission via a certain communication port. At step 915, the software application either directly or through a driver software submits a request for a free data pointer to buffer manger 100. At step 920, the control software determines if a free data pointer is available in RFQ 232. If no free data pointers are available then the control software at step 922 either drops the packet or generates an error message.

If a free data pointer is available, then at step 925 a data pointer is forwarded to the software application. After the data pointer is forwarded, at step 927, the control software examines RFQ 232 (FIG. 2) to determine if a minimum threshold is reached. If the number of data pointers stored in RFQ 232 is below the threshold level, then one or more data pointers are DMA transferred from the external memory to RFQ 232 for efficiency purposes as described earlier. Once the application software receives the data pointer, then at step 930, the application software copies the data in the data buffer pointed to by the data pointer, via a DMA transfer. At step 935, control software determines if the data buffer is full or if an end of packet has been received. If not, then the system reverts back to step 930 and continues to DMA transfer data to the data buffer until it is either full, or until the entire data for the communication packet is stored therein. Otherwise, at step 940 the application software generates a BD including the data pointer pointing to the data buffer.

At step 945, application software queues the BD in TRQ 236 (FIG. 2) in accordance with priority schemes programmed into the system based on QoS requirements. In embodiments of the system, if TRQ 236 reaches a maximum threshold, then one or more BDs are DMA transferred to a queue in external memory to ensure that newly arrived BDs can be quickly stored in TRQ 236. At step 950, I/O core 290 reads the BD from TRQ 236. If TRQ 236's level falls below a minimum threshold, then one or more BDs stored in the external memory, if any, are DMA transferred to TRQ 236, as stated earlier. At step 955, I/O core 290 returns the data pointer that was associated with the transmitted information to WFQ 238.

In one or more embodiments of the system, after the data pointer is returned to WFQ 238 the control program examines WFQ 238 to determine whether a maximum threshold limit has been reached. If so, as described earlier, one or more data pointers are DMA transferred to external memory, at step 957. I/O core 290 forwards the packet to its destination at step 960.

LAYER 2 SWITCHING

In a network environment, communication packets are handled at different stages of communication by different communication layers defined in the Open System Interconnection (OSI) model. The OSI model is a standard that defines seven layers for the modular management of various aspects of communication. Based on this model, data is assembled into communication packets and transmitted from one layer to the next, starting at the top layer in one communication node, proceeding to the bottom layer, over the communication channel to the next communication node and back up the hierarchy. In this process the communication packet may be segmented and reassemble into one or more different formats. Each packet includes information identifying a destination node (e.g., a destination address).

The communication protocol that handles routing of a communication packet based on the physical address of source and destination nodes is referred to as Layer 2 or the “data link layer.” The data link layer is responsible for ensuring that the bits received at the destination node are the same as the bits sent from the source node. The IEEE 802 specification for LANs breaks the data link layer into two sublayers: the LLC (Logical Link Control) and MAC (Media Access Control). The LLC layer provides a common interface point to the MAC layers. The MAC layers specify the access method used.

At Layer 2, the destination address of a communication packet is inspected by a communication controller (e.g., a bridge or a switch) for data routing purposes. In accordance with one or more embodiments of the system, during a Layer 2 switching at an Ethernet port (e.g., MAC port), an I/O controller (e.g., MAC controller) filters out packets destined for the upper layers of the OSI model (i.e., the upper networking layers) by comparing the Ethernet address of the port with the destination address of the packet. The Ethernet address of a port is a unique number maintained by Institute of Electrical and Electronics Engineers (IEEE) New York, N.Y., and assigned to uniquely identify the port for data communications purposes. Packets with addresses that do not match the Ethernet address of the port are forwarded at Layer 2 level to the destination address by the CPU's switching or bridging software.

In accordance with one aspect of the system, the receiving port's Ethernet address is preprogrammed into a register so that it is readily available for comparison with the destination address of the packet, once the packet is received. The I/O controller performs the comparison after receiving a packet. If the preprogrammed Ethernet address does not match the destination address, then the I/O controller set one or more bits in the packet's status field, for example, to indicate that the packet can be forwarded at Layer 2 level without having to be routed to the upper networking layers. Table 6 is an example of a BD, in accordance with one embodiment of the system, wherein the A and B status bits can be configured to indicate that the destination address for the packet matches the programmed Ethernet address.

TABLE 6
Exemplary BD

| | | | | | | | | | | | | | | |
|---|---|---|---|---|---|---|---|---|---|---|---|---|---|---|
| Word | 15 | 14 | 13 | 12 | 11 | 10 | 9 | 8 | 7 | 6 | 5 | 4 | 3 2 | 1 0 |

| | | | | | | |
|---|---|---|---|---|---|---|
| 0 | Destination Address | Status and Control | B | A | Identifier | Type |
| | Hash | | | | | |

| | | |
|---|---|---|
| 1 | Source Address Hash | Data Length |

| | | |
|---|---|---|
| 2 | Data Pointer [23:16] | Data Pointer [31:24] |
| 3 | Data Pointer [7:0] | Data Pointer [15:8] |

The A and B bits can be configured by the I/O controller to designate the destination nodes and the manner in which a communication packet is to be transmitted. For example, “00” can indicate that the preprogrammed Ethernet address does not match the destination address, and that the packet is to be sent to a single node (e.g., unicast). Other bit configurations (e.g., “01”, “10”, or “11”) can indicate that the preprogrammed address and the Ethernet address match and that the packet is to be transmitted to one or more nodes in the network (e.g., unicast, broadcast, or multicast).

Once the CPU reads a BD from RRQ 234, (FIG. 2) the CPU examines the status bit to determine if the communication packet being processed at step 740 is destined for the upper networking layers. If so, the communication packet is copied to the data buffers maintained by the networking stack software and the data pointer associated with the data buffer where the communication packet (or part thereof) was stored is returned back to WFQ 238.

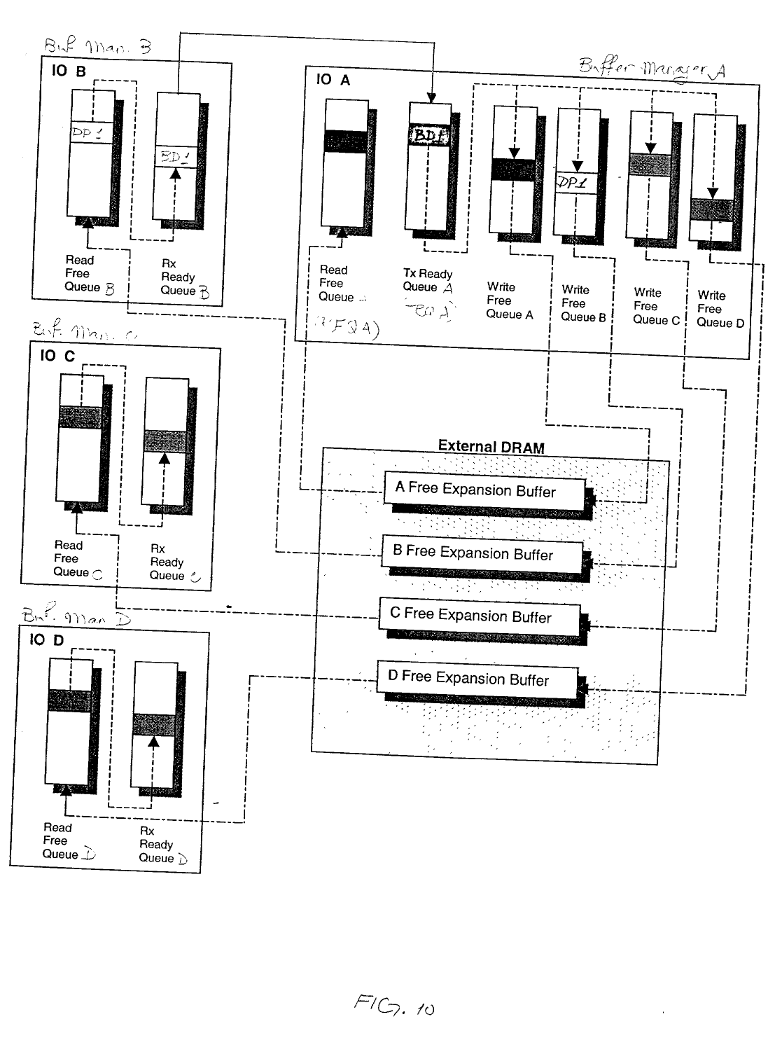

In certain embodiments, each I/O port may be associated with a separate TRQ 236. If the CPU determines that the BD can be switched at Layer 2 level, then the CPU forwards the BD to TRQ 236 associated with the destination I/O port. After the communication packet has been forwarded, the data pointer associated with the BD for the packet will be returned by I/O core 290 to WFQ 232 of the I/O port where the BD was originally stored. As illustrated in FIG. 10, in embodiments of the system, the buffer manager for an I/O port includes a separate WFQ for each I/O port so that freed data pointers for BDs received from the other I/O ports can be returned to the appropriate RFQ from which the data pointer was initially read.

For example, as illustrated in FIG. 10, a communication packet received by I/O port B may be destined for transmission through I/O port A. In accordance with one embodiment, a data pointer DPI is read from RFQ B and a buffer descriptor BD1 is stored in RRQ B to handle the packet as received by buffer manager B. After the packet is processed by buffer manager B, BD1 is copied to TRQ A from RRQ B in a Layer 2 switching scenario. Once the communication packet is transmitted via port A, then DP1 is freed and should be returned to RFQ B, where it was originated. Referring to Tables 1 and 2 above, the identifier field is configured to identify the I/O port from which a packet was received, and therefore the RFQ associated with that I/O port. In accordance with one embodiment, a 2-bit field can identify up to four I/O ports (e.g., 00, 01, 10, 11).

In accordance with one aspect of the system, buffer manager A includes a separate WFQ (e.g., WFQ A, WFQ B, WFQ C) for each I/O port in the system. Thus, DP1 is copied to WFQ B once it is freed, since the identifier field designates I/O B as the originating I/O port. In some embodiments, if RFQ B level has not reached a maximum threshold, DPI can be directly copied to RFQ B via the CBUS. Otherwise, DP1 is transferred from WFQ B to external memory first. DP1 is DMA transferred to RFQ B from the external memory via the MBUS when RFQ B level falls below the maximum threshold. As shown in FIG. 10, in certain embodiments, separate expansion buffers are allocated in external memory for each I/O port so that data pointers can be temporarily stored until they are transferred over to the RFQ from which they were originated.

EXPANSION OF BUFFER DESCRIPTORS TO EXTERNAL MEMORY

In one or more embodiments of the system, to maximize processing speed it is desirable for buffer descriptors to be stored in on-chip memory rather than external memory. However, the on-chip memory dedicated to holding the buffer management queues (e.g., RRQ 234 and TRQ 236) must be kept to a reasonable size to be economically feasible. Due to this limitation, some of the buffer descriptors generated for processing communication packets in the buffer management system of this invention are transferred in external memory when the on-chip memory reaches a maximum threshold (i.e., reaches capacity). Thus, in certain embodiments of the system, on-chip buffer management queues (e.g., RRQ 234 and TRQ 236) are implemented so that when they reach a maximum threshold, any additionally generated buffer descriptors are stored in external memory.

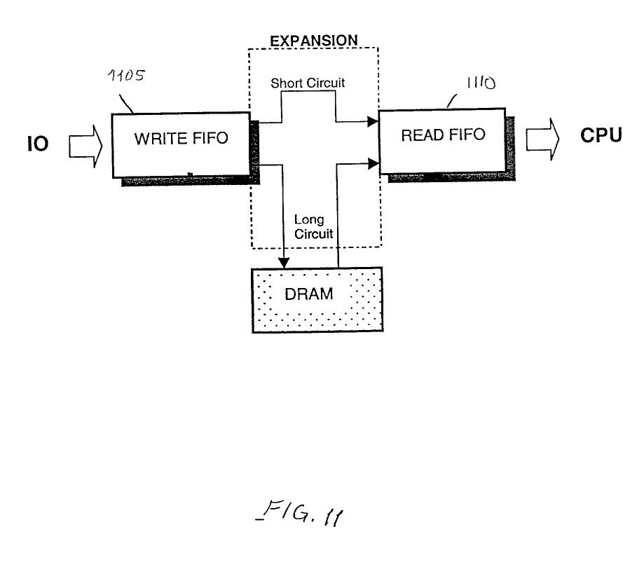

FIG. 11 illustrates a block diagram of a buffer management queue, such as RRQ 234 and TRQ 236, having a write FIFO 1105 and read FIFO 1110, in accordance with one or more embodiments of the system. Write FIFO 1105 is the section of the queue that is written to by I/O core 290 or the CPU. Read FIFO 1110 is the section of the queue from which the CPU or the I/O reads buffer descriptors.

In accordance with one aspect of the system, all BDs written to write FIFO 1105 are automatically moved to read FIFO 1110 in a first mode, referred to as the short circuit mode. In the short circuit mode, the level of BDs stored in read FIFO 1110 is below a maximum threshold level. Thus, BDs can be transferred from write FIFO 1105 to read FIFO 1110 until read FIFO 1110 reaches the maximum threshold (e.g., full). Once read FIFO 1110 reaches that threshold, then write FIFO 1105 waits for read FIFO 1110's level to fall below the maximum threshold before transferring any additional BDs to read FIFO 1110.

In accordance with another aspect of the system, BDs written to write FIFO 1105 that are not immediately transferred to read FIFO 1110 and are queued up in FIFO 1105 until FIFO 1105 reaches a maximum threshold level. If by the time that FIFO 1105 reaches FIFO 1105's maximum threshold, FIFO 1110's level has not fallen below FIFO 1110's maximum threshold, then the system interrupts the CPU to initiate a DMA transfer from write FIFO 1105 to an associated expansion buffer in external memory. This transfer mode is referred to as the long circuit mode.

In the long circuit mode, the CPU initiates a DMA transfer of BDs stored in an associated expansion buffer in external memory to read FIFO 1110, when read FIFO 1110's level falls below its maximum threshold. The DMA transfer continues until read FIFO 1110 reaches it maximum threshold, or until the expansion buffer in external memory is empty. Once the expansion buffer is empty, if read FIFO 1110 has not reached a maximum threshold, the system switches back to the short circuit mode where BDs are directly transferred from write FIFO 1105 to read FIFO 1110.

ATM SEGMENTATION AND REASSEMBLY (SAR) INTERFACE

ATM technology works by transmitting information in a communication stream that consists of fixed-length (e.g., 53-byte) cells. These fixed-length cells allow for fast segmentation and reassembly of communication packets, because it is much faster to process a known packet size than to detect the start and end of variable length packets. Due to the small size of ATM cells, voice and video can be inserted into an ATM communication stream at high frequency for dependable and real-time transmission.

One or more embodiments of the system can be configured to provide an ATM Segmentation and Reassembly (SAR) I/O interface. This interface imposes special requirements of the buffer management system because in contrast to other I/O interfaces, the ATM interface, for example, supports up to 32 different virtual circuits (VCs) and can include interleaved packets arriving from various VCs. A VC is a logical circuit within a physical communication network that provides for a communication path for transmission of communication packets. A communication packet transmitted over the data link layer (i.e., Layer 2) is sometimes referred to as a protocol data unit (PDU). A PDU includes one or more ATM cells that may arrive and end at different periods depending on the network's QoS requirements.

Embodiments of the invention are implemented so that QoS in an ATM stream can be specified, allowing for voice and video to be transmitted in steady successive intervals, thereby providing a smooth media experience. The system supports CBR, rt-VBR, nrt-VBR, ABR, and UBR levels of service. Constant Bit Rate (CBR) guarantees bandwidth for real-time voice and video. Realtime variable Bit Rate (rt-VBR) supports interactive multimedia that requires minimal delays. Non-realtime variable bit rate (nrt-VBR) is used for bursty transaction traffic. Available Bit Rate (ABR) adjusts bandwidth according to congestion levels for LAN traffic. Unspecified Bit Rate (UBR) provides a best effort for non-critical data such as file transfers.

The ATM Adaption Layer (AAL) is the part of the ATM protocol that breaks up application packets into 48-byte payloads, for example. The 48-byte payloads are assembled into ATM cells. In addition to the payload, the ATM cell also includes a 5-byte header, for a total of 53 bytes per cell. The AAL resides between the higher layer transport protocols and the ATM layer. AAL-1 is used for CBR service; AAL-2 for VBR; AAL-3/4 for ABR; and AAL-5 for UBR.

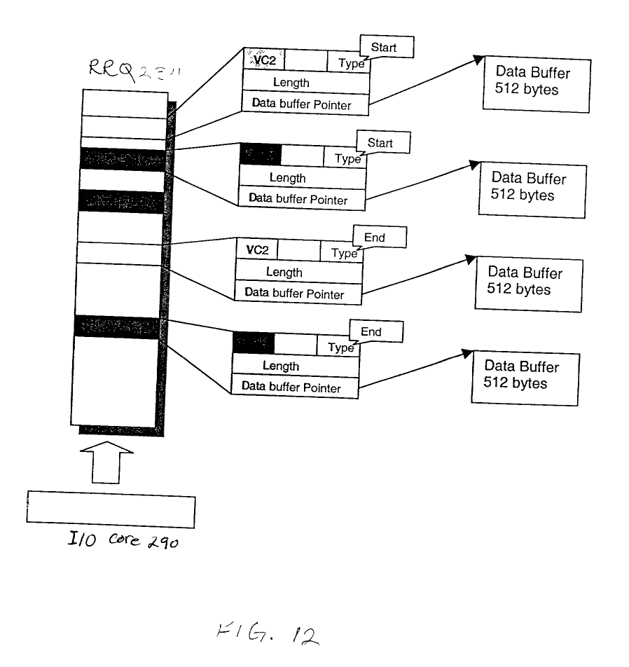

In embodiments of the system, each PDU can be up to 64 KB in size. Therefore, a single PDU (e.g., an AAL-5 frame) may need to be stored in more than one data buffer and therefore associated with more than one BD. In embodiments of the system, separate receive BD queues are allocated for each VC, so that multiple BDs for a single PDU can be grouped in separate and distinct queues. As illustrated in FIG. 12, I/O core 290 writes BDs to RRQ 234 one after another as PDUs are received. Since the system supports more than one VC with PDUs arriving at different time intervals, there is a need for a mechanism to track each BD generated for each PDU cell in association with the particular VC.

In accordance with one aspect of the system, as illustrated in Table 1, a BD for an ATM packet includes a virtual circuit channel number (i.e., channel ID) and a type field. The channel numbers for different VCs are configured by the buffer manager driver during configuration. Upon receipt of a packet, the system detects a VC associated with the packet based on the virtual circuit identifier (VCI) and the virtual path identifier (VPI) of the VC and includes in the BD a virtual circuit channel number to identify the VC associated with the received packet.

The type field, as discussed earlier, indicates whether a BD is the first, middle, or the last BD in a chain of BDs. Table 3 above provides an exemplary embodiment of bit configurations that are used in one or more embodiments of the invention to identify the location of a BD in a BD chain. Referring to FIG. 12, BDs associated with one or more VCs are stored in RRQ 234 as the PDUs are received by I/O core 290.

Embodiments of the system are implemented to include one or more BD ready queues (BRQs) in external memory in association with each VC. Thus, for example, in an embodiment of the system that supports 32 VCs, 32 BRQs are implemented in external memory (not shown). BDs written to RRQ 234 are sorted by the CPU into separate BRQs based on their channel numbers, during processing.

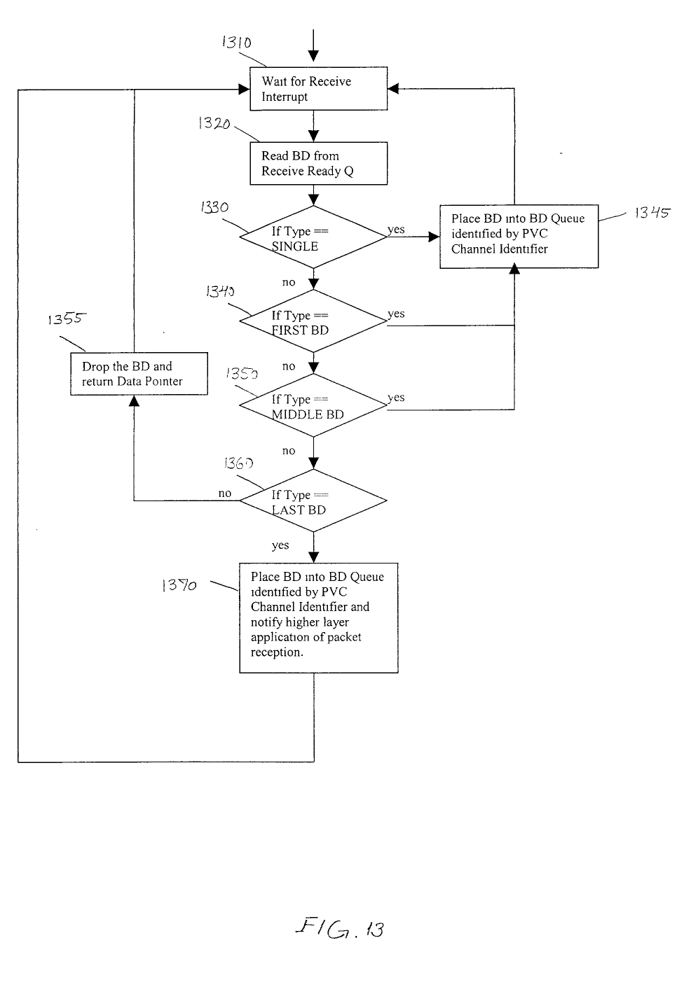

FIG. 13 illustrates a flow diagram of a method of sorting BDs into respective BRQs in external memory during processing and transferring communication packets to higher communication layers. At step 1310, the CPU waits to receive an interrupt signal to read a BD from RRQ 234. At step 1320, CPU reads BD from RRQ 234. At step 1330, the CPU examines the type field in the BD to determine if the BD is the first, middle, or last BD for a communication packet.

If the type field for the BD indicates that the BD is associated with a single communication packet, then at step 1345 the CPU examines the BD's channel number and transfers the BD to the associated BRQ for the identified VC. If the type field indicates that the BD is a first or middle BD in a chain of BDs, then at steps 1340 and 1350, respectively, the CPU DMA transfers the BD from RRQ 234 to the BRQ identified by the channel number of each BD.

If the type field for the BD indicates that the BD is the last BD in the chain of BDs, then at step 1360, the CPU DMA transfers the BD into the BRQ identified by the channel number of that BD and notifies the higher layer application that a packet is received. Else, at step 1355, the CPU drops the BD and returns the data pointer for the BD to the appropriate WRQ, as described earlier.

In embodiments of the system, the size of data buffers can be configured at various capacities. For example, with a buffer size of 512 bytes approximately 10 48-byte cells can be stored in each data buffer. Assuming an I/O data speed of 8 Mbps, for example, the expected rate of interrupts would be approximately 2000 (8 Mbps×1 Byte/8 Bits×1 ISR/512 bytes) ISRs per second, in accordance with one or more embodiments of the system.

As such, a system and method for managing data buffers in a communication system is described in conjunction with one or more embodiments. It should be understood, however, the embodiments disclosed here are provided by way of example. Other methods or system architectures and implementations may be utilized. These and various adaptations and combinations of features of the embodiments disclosed are within the scope of the invention. The invention is defined by the following claims and their full scope of equivalents.

### APPENDIX A

### BUFFER MANAGER INTERFACE

CBUS Interface and Registers

In certain embodiments of the invention, CBUS interface is shared with the I/O core interface. Table A1 provides a description of I/O signals between the CBUS interface and I/O core 290.

TABLE A1
CBUS interface signals between I/O core module

| Number | Signal | I/O | Description |
|---|---|---|---|
| 1 | CbusAD_BM[31:0] | Input | CBUS Address/Data bus to |
| | | | register |
| 2 | Cbus_valid | Input | CBUS command valid |
| 3 | CbusWr_NotRd | Input | CBUS write/read |
| | | | 1: write mode |
| | | | 0: read mode |
| 4 | BM_Rdata[31:0] | Output | Register data return to CBUS. |

Table A2 provides a summary of registers included in CBUS interface and registers 260.

TABLE A2
Register summary

| | | |
|---|---|---|
| Address | | |
| offset | Register | Description |

| | |
|---|---|
| 0 | Threshold register 1 |
| 1 | Threshold register 2 |
| 2 | Threshold register 3 |
| 3 | Data buffer base address |
| 4 | Interrupt status |
| 5 | Interrupt enable |
| 6 | Control |
| 7 | RFQ |
| 8 | RRQ |
| 9 | TRQ 1 |
| 10 | TRQ 2 |
| 11 | TRQ 3 |
| 12 | TRQ 4 |
| 13 | WFQ |
| 14 | DMA command |
| 15 | BRQ expansion counters |
| 16 | TRQ 1 expansion counters |
| 17 | TRQ 2 expansion counters |
| 18 | TRQ 3 expansion counters |
| 19 | TRQ 4 expansion counters |
| 20 | Current DMA |
| 21 | FIFO status FIFO pointer |
| 22 | FIFO status data |
| 23 | TRQ pointer read |
| 24 | BRQ frame counter |

Tables A3 through A26 provide a detailed description of registers included in interface and registers 260, in accordance with one embodiment of the on.

TABLE A3
Threshold register 1

| | | | | |
|---|---|---|---|---|
| Bit | | | | |
| field | Name | R/W | default | Description |

| | | | |
|---|---|---|---|
| 15:8 | BRQ FIFO threshold | R/W | 0 |
| 7:0 | Read Free FIFO threshold | R/W | 0 |

In embodiments of the system, TRQ write FIFO and TRQ read FIFO use hreshold value set by this register.

TABLE A4
Threshold register 2

| | | | | |
|---|---|---|---|---|
| Bit | | | | |
| field | Name | R/W | default | Description |

| | | | |
|---|---|---|---|
| 31:24 | TRQ 4 FIFO threshold | R/W | 0 |
| 23:16 | TRQ 3 FIFO threshold | R/W | 0 |
| 15:8 | TRQ 2 FIFO threshold | R/W | 0 |
| 7:0 | TRQ 1 FIFO threshold | R/W | 0 |

TABLE A5
Threshold register 3

| | | | | |
|---|---|---|---|---|
| Bit | | | | |
| field | Name | R/W | default | Description |

| | | | |
|---|---|---|---|
| 31:24 | Write Free FIFO 4 threshold | R/W | 0 |
| 23:16 | Write Free FIFO 3 threshold | R/W | 0 |
| 15:8 | Write Free FIFO 2 threshold | R/W | 0 |
| 7:0 | Write Free FIFO 1 threshold | R/W | 0 |

TABLE A6
Data buffer base address register

| Bit | | | | |
|---|---|---|---|---|
| field | Name | R/W | default | Description |
| 8:0 | Data buffer base address | R/W | 0 | Upper 9 bits of base |
| | | | | address |

The buffer manager conveys information to the CPU and requests actions from the CPU by means of one or more interrupt signals requests (ISR). The interrupt status is latched until cleared by the CPU. Writing “1” to one or more of the bits in the interrupt status register will reset (set to “0”) that status bit. If the interrupt condition still remains, that bit will be set again. Writing “0” does not do anything. RRQ interrupt is set to “1” when RRQ has data and “frame_cmp” input is set to “1”. FIFO illegal condition interrupt is set to “1” when FIFO overflow/underflow occurs, or MSB of expansion counter goes “1”. This interrupt is reset when FIFO illegal condition interrupt bit (bit[17]) is set to “1”. All the other interrupts are set to “1” when FIFO level matches threshold level.

TABLE A7
Interrupt status register

| Bit | | | | |
|---|---|---|---|---|
| field | Name | R/W | default | Description |
| 17 | FIFO illegal condition interrupt | R | 0 | 1: interrupt |
| | | | | 0: no interrupt |
| 16 | Frame counter interrupt | R | 0 | 1: interrupt |
| | | | | 0: no interrupt |
| 15 | BRQ Ready FIFO data ready | R | 0 | 1: interrupt |
| | interrupt | | | 0: no interrupt |
| 14 | Write Free FIFO 4 interrupt | R | 0 | 1: interrupt |
| | | | | 0: no interrupt |
| 13 | Write Free FIFO 3 interrupt | R | 0 | 1: interrupt |
| | | | | 0: no interrupt |
| 12 | Write Free FIFO 2 interrupt | R | 0 | 1: interrupt |
| | | | | 0: no interrupt |
| 11 | Write Free FIFO 1 interrupt | R | 0 | 1: interrupt |
| | | | | 0: no interrupt |
| 10 | TRQ 4 read FIFO interrupt | R | 0 | 1: interrupt |
| | | | | 0: no interrupt |
| 9 | TRQ 4 write FIFO interrupt | R | 0 | 1: interrupt |
| | | | | 0: no interrupt |
| 8 | TRQ 3 read FIFO interrupt | R | 0 | 1: interrupt |
| | | | | 0: no interrupt |
| 7 | TRQ 3 write FIFO interrupt | R | 0 | 1: interrupt |
| | | | | 0: no interrupt |
| 6 | TRQ 2 read FIFO interrupt | R | 0 | 1: interrupt |
| | | | | 0: no interrupt |
| 5 | TRQ 2 write FIFO interrupt | R | 0 | 1: interrupt |
| | | | | 0: no interrupt |
| 4 | TRQ 1 read FIFO interrupt | R | 0 | 1: interrupt |
| | | | | 0: no interrupt |
| 3 | TRQ 1 write FIFO interrupt | R | 0 | 1: interrupt |
| | | | | 0: no interrupt |
| 2 | RFQ FIFO interrupt | R | 0 | 1: interrupt |
| | | | | 0: no interrupt |
| 1 | BRQ read FIFO interrupt | R | 0 | 1: interrupt |
| | | | | 0: no interrupt |
| 0 | BRQ write FIFO interrupt | R | 0 | 1: interrupt |
| | | | | 0: no interrupt |

TABLE A8
Interrupt enable register

| Bit | | | | |
|---|---|---|---|---|
| field | Name | R/W | default | Description |
| 17 | FIFO illegal condition | R/W | 0 | 1: interrupt enable |
| | | | | 0: interrupt disable |
| 16 | Frame counter interrupt | R/W | 0 | 1: interrupt enable |
| | | | | 0: interrupt disable |
| 15 | BRQ FIFO data ready | R/W | 0 | 1: interrupt enable |
| | interrupt | | | 0: interrupt disable |
| 14 | WRQ FIFO 4 interrupt | R/W | 0 | 1: interrupt enable |
| | | | | 0: interrupt disable |
| 13 | WRQ FIFO 3 interrupt | R/W | 0 | 1: interrupt enable |
| | | | | 0: interrupt disable |
| 12 | WRQ FIFO 2 interrupt | R/W | 0 | 1: interrupt enable |
| | | | | 0: interrupt disable |
| 11 | WRQ FIFO 1 interrupt | R/W | 0 | 1: interrupt enable |
| | | | | 0: interrupt disable |
| 10 | TRQ 4 read FIFO interrupt | R/W | 0 | 1: interrupt enable |
| | | | | 0: interrupt disable |
| 9 | TRQ 4 write FIFO interrupt | R/W | 0 | 1: interrupt enable |
| | | | | 0: interrupt disable |
| 8 | TRQ 3 read FIFO interrupt | R/W | 0 | 1: interrupt enable |
| | | | | 0: interrupt disable |
| 7 | TRQ 3 write FIFO interrupt | R/W | 0 | 1: interrupt enable |
| | | | | 0: interrupt disable |
| 6 | TRQ 2 read FIFO interrupt | R/W | 0 | 1: interrupt enable |
| | | | | 0: interrupt disable |
| 5 | TRQ 2 write FIFO interrupt | R/W | 0 | 1: interrupt enable |
| | | | | 0: interrupt disable |
| 4 | TRQ 1 read FIFO interrupt | R/W | 0 | 1: interrupt enable |
| | | | | 0: interrupt disable |
| 3 | TRQ 1 write FIFO interrupt | R/W | 0 | 1: interrupt enable |
| | | | | 0: interrupt disable |
| 2 | RFQ FIFO interrupt | R/W | 0 | 1: interrupt enable |
| | | | | 0: interrupt disable |
| 1 | BRQ read FIFO interrupt | R/W | 0 | 1: interrupt enable |
| | | | | 0: interrupt disable |
| 0 | BRQ write FIFO interrupt | R/W | 0 | 1: interrupt enable |
| | | | | 0: interrupt disable |

According to one or more embodiments of the system, on power-up, the lstate is in “halt” state. Control software programs these 2 bits to “run” to start buffer management. Software can program these bits to 2'b10 to reset buffer management module. On completion of the reset sequence, the hardware will set lstate to “halt” (default). When a reset is issued all pending DMA commands in the queues will be flushed. DMA command that has already started (transfer in progress or memory request already issued by the DMA command sequencer) will be allowed to complete; the reset sequence will wait until the transfer is finished.

TABLE A9
Control register

| Bit | | | | |
|---|---|---|---|---|
| field | Name | R/W | default | Description |
| 31:30 | Lstate | R/W | 2′b11 | 00: run; |
| | | | | 11; halt; (default) |
| | | | | 10: reset, reset entire buffer |
| | | | | management and Interface |
| 29:9 | Reserved | | | |
| 8:7 | WFQ destination | R/W | 0 | When CPU write data |
| | | | | pointer through WFQ |
| | | | | register, these bits |
| | | | | determine which queue to |
| | | | | write. |
| | | | | 00: WFQ 1 |
| | | | | 01: WFQ 2 |
| | | | | 10: WFQ 3 |
| | | | | 11: WFQ 4 |
| 6:5 | TRQ configuration | R/W | 0 | 00: queue 1 ˜ 4 = 32 entry |
| | | | | 01: queue 1 ˜ 2 = 40 entry |
| | | | | queue 3 ˜ 4 = 24 entry |
| | | | | 10: queue 1 = 80 entry |
| | | | | queue 2 ˜ 3 = 24 entry |
| | | | | 11: queue 1 ˜ 2 = 64 entry |
| 4 | TRQ 4 expansion | R/W | 0 | 1: Short circuit |
| | | | | 0: Automatic expansion |
| 3 | TRQ 3 expansion | R/W | 0 | 1: Short circuit |
| | | | | 0: Automatic expansion |
| 2 | TRQ 2 expansion | R/W | 0 | 1: Short circuit |
| | | | | 0: Automatic expansion |
| 1 | TRQ 1 expansion | R/W | 0 | 1: Short circuit |
| | | | | 0: Automatic expansion |
| 0 | BRQ expansion | R/W | 0 | 1: Short circuit |
| | | | | 0: Automatic expansion |

TABLE A10
RFQ register

| Bit | | | | |
|---|---|---|---|---|
| field | Name | R/W | default | Description |
| 31:0 | RFQ data | R | 0 | Data buffer pointer (read) |
| | | | | Read all 1's if Read Free FIFO |
| | | | | is empty |

TABLE A11
RRQ register

| Bit | | | | |
|---|---|---|---|---|
| field | Name | R/W | default | Description |
| 31:0 | RRQ data | R | 0 | 1^{st} read: Lower word of BD |
| | | | | 2^{nd} read: Upper word of BD |
| | | | | Read all 1's if Rx BD Ready |
| | | | | read FIFO is empty |

TABLE A12
TRQ register

| Bit | | | | |
|---|---|---|---|---|
| field | Name | R/W | default | Description |
| 31:0 | TRQ data | R/W | 0 | 1^{st} write: Lower word of BD |
| | | | | 2^{nd} write: Upper word of BD |
| | | | | Read all 1's if Rx BD Ready |
| | | | | write FIFO is full |

Bit [22:7] of this 32 bit data will be written into WFQ FIFO selected by WFQ destination bit in control register.

TABLE A13
WFQ register

| Bit | | | | |
|---|---|---|---|---|
| field | Name | R/W | default | Description |
| 31:0 | WFQ data | R/W | 0 | Data buffer pointer (write) |
| | | | | Read all 1's if Read Free FIFO |
| | | | | is full |

In embodiments of the invention, DMA process will be initiated by this register. When CPU accesses this register, DMA request will be queued to DMA request FIFO. Channel bits indicates which DRAM transaction needs to be done.

TABLE A14
DMA command register

| | | | | |
|---|---|---|---|---|
| Bit | | | | |
| field | Name | R/W | default | Description |

| | | | |
|---|---|---|---|
| 31:28 | Channel | R/W | 0 |
| 27:23 | Transfer size [4:0] | R/W | 0 |
| 22:0 | DRAM address [22:0] | R/W | 0 |

DMA commands are issued by the CPU during expansion operations to move blocks of data between the FIFOs on chip and the expansion buffers in external memory. In embodiments of the system, DRAM address [31:23] is pointed by bit [8:0] of data buffer base address register. Transfer size register determines how many word to transfer from/to DRAM. If Transfer size[4:0]=5'b 11111, threshold value defined by threshold register 1-3 are used for DRAM transfer size. Otherwise, this register value multiplied by 4 is used for DRAM transfer size. Minimum transfer size is 4 (Transfer size[4:0]=5'b00001) and maximum transfer size is 120(Transfer size[4:0]=5'b11110), step size is always 4. Channel bits indicates following transactions. When DMA command is issued, corresponding interrupt is negated. After DMA command is granted and transfer is done, interrupt logic is enabled.

For example, Read Free FIFO DMA command is issued by CPU, Read Free FIFO interrupt is disabled by hardware since this interrupt procedure is handled or performed. After Read Free FIFO DMA request is popped out of this DMA request FIFO and DMA transaction finished, Read Free FIFO interrupt is enabled.

TABLE A15
DMA command detail

| Bit31 | Bit30 | Bit29 | Bit28 | Channel |
|---|---|---|---|---|
| 0 | 0 | 0 | 0 | Rx Ready Write FIFO expansion DMA |
| | | | | (write) |
| 0 | 0 | 0 | 1 | Rx Ready Read FIFO expansion DMA (read) |
| 0 | 0 | 1 | 0 | Read Free FIFO DMA (read) |
| 0 | 0 | 1 | 1 | Tx 1 Ready Write FIFO expansion DMA |
| | | | | (write) |
| 0 | 1 | 0 | 0 | Tx 1 Ready Read FIFO expansion DMA |
| | | | | (read) |
| 0 | 1 | 0 | 1 | Tx 2 Ready Write FIFO expansion DMA |
| | | | | (write) |
| 0 | 1 | 1 | 0 | Tx 2 Ready Read FIFO expansion DMA |
| | | | | (read) |
| 0 | 1 | 1 | 1 | Tx 3 Ready Write FIFO expansion DMA |
| | | | | (write) |
| 1 | 0 | 0 | 0 | Tx 3 Ready Read FIFO expansion DMA |
| | | | | (read) |
| 1 | 0 | 0 | 1 | Tx 4 Ready Write FIFO expansion DMA |
| | | | | (write) |
| 1 | 0 | 1 | 0 | Tx 4 Ready Read FIFO expansion DMA |
| | | | | (read) |
| 1 | 0 | 1 | 1 | Write Free FIFO A DMA (write) |
| 1 | 1 | 0 | 0 | Write Free FIFO B DMA (write) |
| 1 | 1 | 0 | 1 | Write Free FIFO C DMA (write) |
| 1 | 1 | 1 | 0 | Write Free FIFO D DMA (write) |
| 1 | 1 | 1 | 1 | reserved |

TABLE A16
BRQ expansion counter register

| Bit | | | | |
|---|---|---|---|---|
| field | Name | R/W | default | Description |
| 15:0 | BRQ expansion counters | R/W | 0 | DRAM transaction |
| | | | | counter value |
| | | | | For monitoring |
| | | | | purpose |

TABLE A17
TRQ expansion counter register

| Bit | | | | |
|---|---|---|---|---|
| field | Name | R/W | default | Description |
| 15:0 | TRQ expansion counters | R/W | 0 | DRAM transaction |
| | | | | counter value |
| | | | | For monitoring |
| | | | | purpose |

TABLE A18
Current DMA register

| | | | | |
|---|---|---|---|---|
| Bit | | | | |
| field | Name | R/W | default | Description |

| | | | |
|---|---|---|---|
| 31:28 | Channel | R | 0 |
| 27:0 | DRAM address [27:0] | R | 0 |

This register selects FIFO to monitor its status. Only one bit can be set to “1”.

TABLE A19
FIFO status FIFO pointer

| Bit | | | | |
|---|---|---|---|---|
| field | Name | R/W | default | Description |
| 14:0 | FIFO pointer | R/W | 0 | Bit 0 = 1: RFQ FIFO |
| | | | | Bit 1 = 1: BRQ write FIFO |
| | | | | Bit 2 = 1: BRQ read FIFO |
| | | | | Bit 3 = 1: TRQ write FIFO 1 |
| | | | | Bit 4 = 1: TRQ write FIFO 2 |
| | | | | Bit 5 = 1: TRQ write FIFO 3 |
| | | | | Bit 6 = 1: TRQ write FIFO 4 |
| | | | | Bit 7 = 1: TRQ read FIFO 1 |
| | | | | Bit 8 = 1: TRQ read FIFO 2 |
| | | | | Bit 9 = 1: TRQ read FIFO 3 |
| | | | | Bit 10 = 1: TRQ read FIFO 4 |
| | | | | Bit 11 = 1: WFQ FIFO 1 |
| | | | | Bit 12 = 1: WFQ FIFO 2 |
| | | | | Bit 13 = 1: WFQ FIFO 3 |
| | | | | Bit 14 = 1: WFQ FIFO 4 |

TABLE A20
FIFO status data

| | | | | |
|---|---|---|---|---|
| Bit | | | | |
| field | Name | R/W | default | Description |

| | | | |
|---|---|---|---|
| 25:18 | FIFO read address | R | 0 |
| 17:10 | FIFO write address | R | 0 |
| 9:2 | FIFO level | R | 0 |
| 1 | Full | R | 0 |
| 0 | Empty | R | 1 |

Initiate data pointer read operation for TRQ (data pointer) read through CBUS. Setting bit 31 initiates read operation for TRQ, this bit is automatically reset. This function is not be used with normal I/O core request.

TABLE A21
TRQ pointer read

| Bit | | | | |
|---|---|---|---|---|
| field | Name | R/W | default | Description |
| 31 | Start read | R/W | 0 | Initiate data pointer read |
| | | | | operation from TRQ. Reset |
| | | | | after this operation finishes. |
| 30:27 | FIFO empty[3:0] | R | 1111 | “1” when TRQ write FIFO |
| | | | | empty & TRQ read FIFO |
| | | | | empty |
| 26:25 | Tx_DP_ID[1:0] | R/W | 0 | Select TRQ. |
| 24:16 | Reserved | | | |
| 15:0 | Tx_DP[15:0] | R | 0 | Data pointer. Updated after |
| | | | | read operation finishes. |

The BRQ Framer Counter is only used as a debugging tool to keep track of how many received frames have not been read out by the CPU. This counter indicates the number of frames of BD stored in RRQ FIFO. This counter is increment when Rx_frame_cmp comes from I/O core, decrement when BD with type[1:0]=2'b00 or type[1:0]=2'b11 read out by CPU.

TABLE A22
BRQ frame counter

| | | | | |
|---|---|---|---|---|
| Bit | | | | |
| field | Name | R/W | default | Description |

| | | | |
|---|---|---|---|
| 31:10 | Reserved | | |
| 9:0 | Rx frame counter | R | 0 |

FIFO illegal condition causes register reports which FIFO condition causes FIFO illegal condition interrupt. Only the very first illegal condition is reported. If multiple FIFO illegal conditions happen exactly at the same time, these multiple causes are reported. All the bits in this register are reset when FIFO illegal condition interrupt bit (bit[17]) of interrupt status register is set to “1”.

TABLE A23
FIFO illegal condition cause register

| Bit | | | | |
|---|---|---|---|---|
| field | Name | R/W | default | Description |
| 28 | FIFO | R | 0 | MSB of expansion counter goes “H” |
| 27 | Illegal | R | 0 | TRQ 4 read FIFO full and DMA push |
| 26 | Interrupt | R | 0 | TRQ 3 read FIFO full and DMA push |
| 25 | cause | R | 0 | TRQ 2 read FIFO full and DMA push |
| 24 | | R | 0 | TRQ 1 read FIFO full and DMA push |
| 23 | | R | 0 | TRQ 4 write FIFO empty and DMA |
| | | | | pop |
| 22 | | R | 0 | TRQ 3 write FIFO empty and DMA |
| | | | | pop |
| 21 | | R | 0 | TRQ 2 write FIFO empty and DMA |
| | | | | pop |
| 20 | | R | 0 | TRQ 1 write FIFO empty and DMA |
| | | | | pop |
| 19 | | R | 0 | RRQ read FIFO full and DMA push |
| 18 | | R | 0 | RRQ write FIFO empty and DMA |
| | | | | pop |
| 17 | | R | 0 | TRQ 4 write FIFO full and CPU push |
| 16 | | R | 0 | TRQ 3 write FIFO full and CPU push |
| 15 | | R | 0 | TRQ 2 write FIFO full and CPU push |
| 14 | | R | 0 | TRQ 1 write FIFO full and CPU push |
| 13 | | R | 0 | RRQ write FIFO full and I/O push |
| 12 | | R | 0 | WFQ 4 empty and DMA pop |
| 11 | | R | 0 | WFQ 3 empty and DMA pop |
| 10 | | R | 0 | WFQ 2 empty and DMA pop |
| 9 | | R | 0 | WFQ 1 empty and DMA pop |
| 8 | | R | 0 | RFQ full and DMA push |
| 7 | | R | 0 | WFQ 4 full and CPU push |
| 6 | | R | 0 | WFQ 3 full and CPU push |
| 5 | | R | 0 | WFQ 2 full and CPU push |
| 4 | | R | 0 | WFQ 1 full and CPU push |
| 3 | | R | 0 | WFQ 4 full and I/O push |
| 2 | | R | 0 | WFQ 3 full and I/O push |
| 1 | | R | 0 | WFQ 2 full and I/O push |
| 0 | | R | 0 | WFQ 1 full and I/O push |

I/O Interface

Table A24 includes description of I/O interface signals for buffer manager 100.

TABLE A24
I/O interface signals

| Number | Signal | I/O | Description |
|---|---|---|---|
| 1 | Rx_DP_mty | Output | No RFQ available |
| 2 | Rx_DP_PTR[15:0] | Output | RFQ data output to I/O |
| | | | core. |
| 3 | Rx_PTR_taken | Input | Current RFQ taken, |
| | | | advance to next pointer |
| 4 | Rx_Rtn_PTR[5:0] | Input | Data pointer, goes to RRQ. |
| 5 | Rx_type[1:0] | Input | 2 bit type information |
| | | | 00: Single BD |
| | | | 01: First of BD chain |
| | | | 10: Middle of BD chain |
| | | | 11: Last of BD chain |
| 6 | Rx_buff_cmp | Input | Current BD complete, |
| | | | update data pointer and |
| | | | type for RRQ |
| 7 | Rx_frame_cmp | Input | Current packet complete, |
| | | | update status, data length |
| | | | and source/destination |
| | | | address for RRQ |
| 8 | Rx_Rtn_ack | Output | Rx_buff_cmp |
| | | | acknowledge |
| 9 | Rx_length[10:0] | Input | Received packet length |
| 10 | Rx_Len_src_adr[4:0] | Input | Source address (MAC) |
| | | | 5′b00001 (USB0) |
| | | | 5′b00010 (USB1) |
| | | | 5′b00100 (Serial port0) |
| | | | 5′b01000 (Serial port1) |
| | | | 5′b10000 (Serial port2) |
| | | | Rx_length[15:11] (ATM) |
| 11 | Rx_VC_dst_adr[4:0] | Input | Destination address (MAC) |
| | | | Virtual Channel (ATM) |
| | | | 5′b00000 |
| | | | (All the other I/O core) |
| 12 | Rx_status[6:0] | Input | TBD |
| 13 | Rx_ID[1:0] | Input | Identifier information |
| 14 | Tx_DP_mty[3:0] | Output | TRQ empty |
| 15 | Tx_TRQ_ID[1:0] | Input | TRQ ID during request |
| 16 | Tx_DP_PTR[15:0] | Output | Current TRQ data pointer |
| 17 | Tx_length[15:0] | Output | Transmit packet data length |
| 18 | Tx_ID[1:0] | Output | ID output from TRQ |
| 19 | Tx_Type[1:0] | Output | 2 bit type information for |
| | | | I/O core from TRQ |
| 20 | Tx_VC_ID[4:0] | Output | Virtual Channel for ATM |
| | | | core |
| 21 | Tx_DP_Req | Input | TRQ data pointer request |
| 22 | Tx_ack | Output | TRQ transmit acknowledge |
| 23 | Tx_Rtn_PTR[15:0] | Input | Data pointer, goes to WFQ |
| 24 | Tx_Rtn_ID[1:0] | Input | Return ID input from I/O |
| | | | core |
| 25 | Tx_buff_cmp | Input | Current BD complete, |
| | | | update data pointer and ID |
| | | | for WFQ |
| 26 | Tx_Rtn_ack | Output | Tx_buff_cmp |
| | | | acknowledge |
| 27 | OAM_FCS | Output | FCS output when MAC, |
| | | | OAM output when ATM |
| 28 | IO_reset | Output | Reset signal to I/O core, |
| | | | derived from control |
| | | | resister, 1state. |
| 29 | IO_reset_done | Input | Reset complete signal from |
| | | | I/O core. |
| 29 | Base_adr[8:0] | Output | Data buffer base address, |
| | | | direct output from data |
| | | | buffer base address register |
| | | | to I/O module. |
| 30 | Tx_spare[3:0] | Output | Tx_spare output from TRQ |
| | | | FIFO |

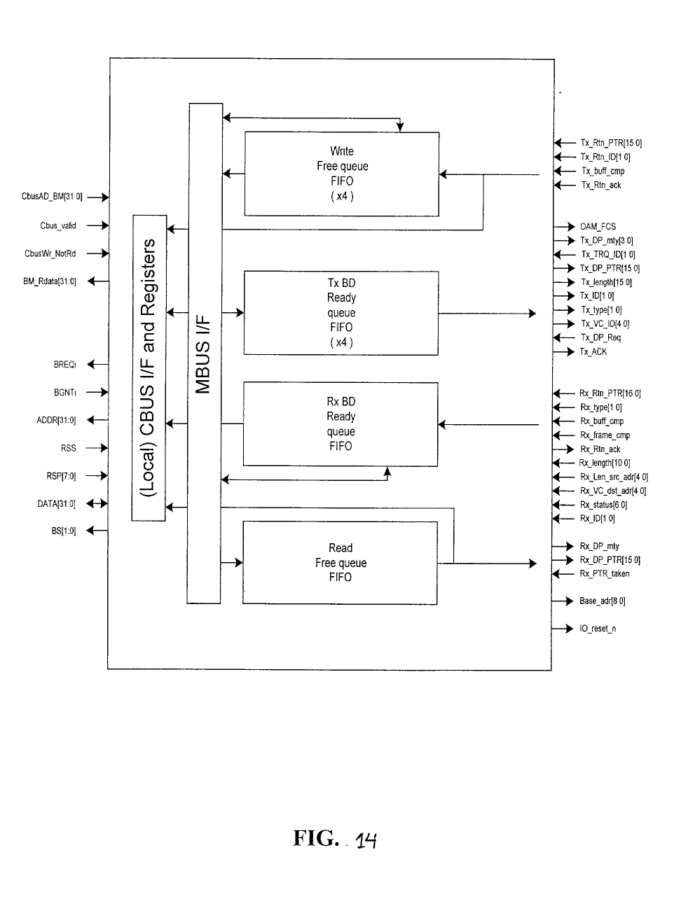

FIG. 14 illustrates a block diagram of buffer manager 100 and the interface signals in accordance with one embodiment of the system.

MBUS Interface

Table A26 provides a description of MBUS interface signals, in accordance with one or more embodiments of the system.

TABLE A26
MBUS interface signals

| Number | Signal | I/O | Description |
|---|---|---|---|
| 1 | BREQi | Output | Bus Request |
| 2 | BGNTi | Input | Bus Grant |
| 3 | ADS | Output | Address Strobe |
| 4 | ADDR[3 1:0] | Output | Address. The first cycle contains the |
| | | | full byte address; the second cycle |
| | | | contains other pertinent information. |
| 5 | RSS | Input | Response Strobe |
| 6 | RSP[7:0] | Input | Response; driven by DMA controller. |
| | | | RSP[7]: Direction 0: read, |
| | | | 1: write |
| | | | RSP[6:2]: Bus Agent ID |
| | | | RSP[1:0]: transfer tag |
| 7 | DATA[31:0] | Inout | 32-bit data either driven by the DMA |
| | | | controller (memory read), or the bus |
| | | | agent (memory write). |
| 8 | BS[1:0] | Output | Bank select signal. DRAM address |
| | | | [22:21] |

### APPENDIX B

### BUFFER MANAGER INTERFACE WITH WAN ENGINE

The WAN engine comprises of a RISC CPU, a set of hardware assist logic, and the appropriate WAN protocol firmware. The WAN engine handles the segmentation and assembly of communication packets. The WAN engine interfaces with buffer manager 100 via a set of coprocessor registers. A coprocessor is a secondary processor used to speed up operations by handling some of the workload of the main CPU. Embodiments of the invention are described herein as applicable to a RISC processor and a WAN coprocessor based on a MIPS architecture. This description is provided by way of example, however, and should not be construed as a limitation. Other embodiments of the invention may be implemented using other processor and coprocessor architectures. The following tables list the control and status registers of a WAN coprocessor and CBUS interface 260. In accordance with one aspect of the invention, the control registers map to the set of 32-bit coprocessor control register space of the MIPS architecture, for example.

TABLE B1
Exemplary Coprocessor (CP) Control Register

| CP | | |
|---|---|---|
| Control | | |
| Register | | |
| Number | | |
| (Hex) | Register | Description |
| 0 | WAN_control | WAN control register. (CBUS |
| | | accessible) |
| 1 | WAN_status0 | Status bits |
| 2 | WAN_status1 | |
| 3 | WAN_DMA_cmd | Write port of the 8 words |
| | | deep DMA command queue. |
| 4 | WAN_DMA_addr | Write port of the 8 words |
| | | deep DMA address queue. |
| 5 | WAN_DMA_base_addr | DMA base address |
| 6 | WAN_rx_cmd | Write port of the 8 words |
| | | deep WAN receive command |
| | | FIFO |
| 7 | WAN_tx_cmd | Write port of the 8 words |
| | | deep WAN transmit command |
| | | FIFO |
| 8 | WAN_rdfrq | RFQ pointer |
| 9 | WAN_rxbdq0 | RRQ 1 |
| A | WAN_rxbdq1 | RRQ 2 |
| B | WAN_txbdq0 | TRQ 1 |
| C | WAN_txbdq1 | TRQ 2 |
| D | WAN_wrfrq | WFQ |
| E | WAN_rx_cmd_done | Receive command Done |
| | | Queue (8 deep) |
| F | WAN_tx_cmd_done | Transmit command Done |
| | | Queue (8 deep) |
| 0 × 10 | WAN_DMA_cmd_done | DMA command Done Queue |
| | | (8 deep) |
| 0 × 11 | WAN_CRC_cmd | |
| 0 × 12 | WAN_CRC_input | |
| 0 × 13 | WAN_CRC_state0 | |
| 0 × 14 | WAN_CRC_state1 | |
| 0 × 15 | WAN_IDLE_TX_CMD | Idle cell transmit command |
| 0 × 16 | WAN_IDLE_CNT | Idle cell transmitted counter |
| 0 × 17 | WAN_interrupt_status | Written by WAN-RISC to |
| | | generate interrupt to |
| | | software RISC (CBUS |
| | | accessible) |
| 0 × 18 | WAN_mask | Mask register (CBUS |
| | | accessible) |
| 0 × 19 | WAN_cmd | Command register (CBUS |
| | | accessible) |
| 0 × 1A | WAN_Data | Data register (Cbus |
| | | accessible) |
| 0 × 1B | WAN_DMA_address | Dma address register. |
| | | (Cbus accessible) |
| 0 × 1C | WAN_frame_sizes | Frame and delimiter sizes |
| 0 × 1D | WAN_frame_delimiter | Frame delimiter |
| 0 × 1E | WAN_frame_delimiter_mask | Frame delimiter mask |
| 0 × 1F | WAN_frame | WAN frame info |

TABLE B2
Exemplary CBUS Register

| CBUS | | |
|---|---|---|
| Register | | |
| Number | | |
| (Hex) | Register | Description |
| 0 × 0 | WAN_control | WAN control register. (CP |
| | | accessible) |
| 0 × 4 | WAN_interrupt_status | Written by WAN-RISC to generate |
| | | interrupt to software RISC (CP |
| | | accessible) |
| 0 × 8 | WAN_mask | Mask register (CP accessible) |
| 0 × c | WAN_cmd | Command register (CP accessible) |
| 0 × 10 | WAN_Data | Data register (CP accessible) |
| 0 × 14 | WAN_DMA_address | Dma address register. (CP accessible) |
| 0 × 18 | VCXO_period0 | See NV_vcxo_controller spec. |
| | | CBUS access only |
| 0 × 1c | VCXO_count0 | CBUS access only |
| 0 × 20 | VCXO_period1 | CBUS access only |
| 0 × 24 | VCXO_count1 | CBUS access only |

TABLE B3
Exemplary WAN Control Register

| Bit field | Name | R/W | default | Description |
|---|---|---|---|---|
| 31:30 | 1state | R/W | 2′b10 | 00:run; |
| | | | | 11;halt, (default) |
| | | | | 10:reset, reset the WAN Interface |
| 29 | Rx_reset | R/W | 0 | Reset receive interface - this is a 1- |
| | | | | shot that is set by software and reset |
| | | | | by hardware |
| 28 | Tx_reset | R/W | 0 | Reset transmit interface - this is a 1- |
| | | | | shot that is set by software and reset |
| | | | | by hardware |
| 27 | Debug_Write_enable | R/W | 0 | Write enable for bits 26:24 |
| 26:24 | Debug | R/W | 0 | For debug purposes only |
| 23:11 | Reserved | R | 0 | |
| 10:9 | WAN_configure | R | | Read only |
| | | | | 00: UTOPIA |
| | | | | 01: Serial, non-HDLC |
| | | | | 11: Serial, HDLC |
| | | | | 10: Terayon |
| 8 | Write_enable for bit | R/W | | Read back 0 |
| | 7 | | | |
| 7 | Busy_bit | R/W | 1′b0 | When SW MIPS writes to |
| | | | | WAN_cmd register, this bit will be |
| | | | | set by hardware. WAN MIPS will |
| | | | | clear it when the command is done |
| 6 | Write_enable for [5:3] | R/W | | Read back 0. |
| 5 | ODD_PRTY | R/W | 1′b0 | 1: odd parity, 0: even parity |
| 4 | EN_UTOPIA_PRTY | R/W | 1′b0 | Enable Parity for UTOPIA Interface |
| 3 | EN_IDLE_INSERTI | R/W | 0 | This bit controls the behavior of the |
| | ON | | | interface hardware if the transmit |
| | | | | queue is empty. If set hardware will |
| | | | | insert idle cells. |
| 2 | EN_TX_TRQ_ID | R/W | 0 | Enable bit to write transmit ready |
| | | | | queue. If one it will update bits 1:0 |
| | | | | else do nothing. |
| 1:0 | TX_TRQ_ID | R/W | 00 | ID for reading Transmit ready queue. |

On power-up, the lstate is in “halt” state (e.g., “11”). Software running on the MIPS programs the lstate's 2 bits to “run” state (e.g., “00”) to start the WAN core. The WAN CORE is the on-chip hardware logic that performs the function of integrating the FWAN CPU with the rest of the FWAN hardware assist modules as well as to he system outside of the FWAN module. The MIPS software can program these bits to 2'b10 to reset the WAN core and the coprocessor interface. On completion of the reset sequence, the hardware will set lstate to back to “halt” (default) state. When a reset is issued, all pending WAN and DMA commands in the FIFO 230 queues will be flushed. A DMA command that has already started (e.g., if data transfer is in progress or if a memory request is already issued by the DMA command sequencer) will be allowed to complete. Thus, the reset sequence will wait until the transfer is finished.

Table B4 describes the contents of the FWAN Control Register. This register is primarily used to determine the status of specific command and command done queues as well as to determine when a queue command request has been acknowledged. The acknowledge status bits are used to indicate to the FWAN CPU that a read or write to a command queue is permitted. This allows previous commands to complete execution before new commands are entered.

TABLE B4
WAN Status 1 Register

| Bit field | Name | R/W | default | Description |
|---|---|---|---|---|
| 31:16 | reserved | | | |
| 14 | Dma_cmd_doneq_empty | R | 1 | DMA command done queue empty |
| 13 | Dma_cmdq_full | R | 0 | DMA command queue full |
| 12 | Tcmd_doneq_empty | R | 1 | Transmit command done queue is |
| | | | | empty. |
| 11 | Tcmdq_full | R | 0 | DMA done command queue is full. |
| 10 | Rcmd_doneq_empty | R | 1 | Receive done command queue is |
| | | | | empty. |
| 9 | Rcmdq_full | R | 0 | Receive command queue is full |
| 8 | TFQ_ACK | R | 1 | Transmit free queue acknowledge. |
| 7 | TX_ACK | R | 1 | TRQ ack. |
| | | | | 1 = can read from TXRD[1:0] |
| | | | | 0 = cannot read from TXRD[1:0] - BM |
| | | | | pre-reading the queue. |
| 6:3 | TRQ_empty | R | 0xf | TRQ status |
| | | | | 1: Empty |
| | | | | 0: Non-empty |
| | | | | bit 3:TRQ0, bit 4:TRQ1, bit 5:TRQ2, |
| | | | | bit6:TRQ3 |
| 2 | Reserved | R | 0 | |
| 1 | RX_RTN_ACK | R | 1 | RRQ acknowledge |
| | | | | 1 = can write into RXRD[1:0] register |
| | | | | 0 = cannot write into RXRD[1:0] |
| | | | | register (previous write in progress). |
| 0 | Rfrq_empty | R | 1 | RFQ fullness |
| | | | | 1 = empty, 0 = non-empty |

Table B5 contains the descriptions of the command queue fullness registers. These registers are used to inform the FWAN CPU whether a particular command queue is full or empty. If a command queue is deemed not empty, then the CPU is free to queue a new command. Similarly, if a command done queue is not empty, the CPU should proceed to read out the contents of the queue until it is empty.

TABLE B5
WAN Status 0 Register

| Bit field | Name | R/W | default | Description |
|---|---|---|---|---|
| 25:22 | Tcmd_done_qfullness | R | 0 | Transmit command done queue |
| | | | | fullness |
| | | | | 0 = empty; 4 = full |
| 21:18 | Rcmd_done_qfullness | R | 0 | Receive command done queue fullness |
| | | | | 0 = empty; 4 = full |
| 17:13 | Dma_done_qfullness | R | 0 | DMA command done queue fullness |
| | | | | 0 = empty; 8 = full |
| 12:8 | Dma_qfullness | R | 0 | DMA command queue fullness |
| | | | | 0 = empty; 8 = full |
| 7:4 | transmit_qfullness | R | 0 | Transmit command queue fullness |
| | | | | 0 = empty; 4 = full |
| 3:0 | receive_qfullness | R | 0 | Receive command queue fullness |
| | | | | 0 = empty; 4 = full |

With respect to RFQ 232, the status register includes an empty flag to indicate whether RFQ 232 is non-empty. A read to the co-processor register RFQ_DP returns a 16-bit free data pointer. If the queue is empty the control software does not read RFQ 232 to receive a data pointer.

With respect to RRQ 234, two coprocessor registers (WAN_rxbdq[1:0]) are utilized to provide 46-bits needed for storing a 46-bit concatenated buffer descriptor, for example. Writing to WAN_rxbdql causes the contents of WAN_rxbdq[1:0] to be written to the RRQ 234. Writing to WAN_rxbdq0 updates the register. The writing takes place after the buffer manager acknowledges the previous write. Control software examines the RX_RTN_ACK bit in the WAN_status0 register before writing WAN_rxbdq[1:0] register. In the worst case scenario, an ACK is returned in 12 cycles from a previous write to WAN_rxbdq[1:0] register. If writes to WAN_rxbdq[1:0] register are more then 12 cycles apart then there is no need to examine the RX_RTN_ACK bit. Control software also examines RRQ 234 to ensure that RRQ 234 is not full before writing to WAN_rxbdq[1:0] register.

The 64-bits included in WAN_rxbdq[1:0] are concatenated to 46-bits so that they can be stored in RRQ 234. Because the bits in RRQ 234 are interpreted by control software, any content can be forwarded from the WAN RISC to the main CPU. If more than 46-bits are required, then multiple buffer descriptors can be send to convey the information.

With respect to TRQ 236, where four transmit queues are included, when any of the four transmit queues is non-empty the empty flag will be de-asserted. This will cause an interrupt to the WAN RISC processor to indicate there is at least one entry in one of TRQ 236s. The four empty bits are provided in the WAN_status register. The four transmit queues hold different priority buffer descriptors. The priority algorithm is implemented in software executed by the WAN RISC, in accordance with one or more embodiments of the invention.

The WAN RISC sets the Tx_TRQ_ID (identifying which transmit buffer to read) field in the WAN_control register which starts a read from one of the transmit queues. Once the read is performed, then buffer manager 100 asserts a TX_ACK and writes the transmit queue's content to two co-processor registers WAN_txbdq[1:0]. After the ACK is asserted, WAN RISC reads the WAN_txbdq0 and WAN_txbdq1 co-processor register to get the contents of TRQ 236. Control software examines the TX_ACK bit in the WAN_status register before reading the WAN_txbdq[1:0] registers to verify that the BD in the txbdq register is valid. In accordance with an aspect of the invention, the maximum wait to receive an ACK is 12 cycles from the time the ID register is set because, in embodiments of the invention it takes at least 12 cycles to select the TRQ 236 to read from and to retrieve the BD. Thus, there is no need to examine the ACK bit if the read is be delayed by 12 cycles. Similar to WAN_rxbdq[1:0], WAN_txbdq[1:0] has 46-bits, in certain embodiments of the system. Any information can be passed from the main RISC to the WAN RISC as the bits are interpreted by control software.

With respect to WRQ 238, control software frees a data pointer by writing into the TX_RTN_PTR co-processor register. In embodiments of the system, buffer manager 100's hardware determines the queue in which the pointer will be stored. Thus, thee firmware does not control this operation. If the WRQ 238 is full, the hardware will not issue an ACK. By not issuing an ACK the software cannot free the Data Pointer because that indicates that the WFQ 238 is full. The software does not free the data pointer unless an ACK is received from a previous write.

Table B6 describes the registers used by the FWAN CPU to obtain a free data pointer and to write a BD into RRQ 234. Because each BD is comprised of 8 bytes, their two registers are used in accordance with one or more aspects of the system. One register handles the upper 4 bytes and the other register handles the lower 4 bytes of the BD.

TABLE B6
WAN_rdfrq

| Bit field | Name | R/W | Default | Description |
|---|---|---|---|---|
| 15:0 | RFQ_DP | R | X | Ready Free Queue pointer |

TABLE B7
WAN_rxbdq0

| Bit field | Name | R/W | Default | Description |
|---|---|---|---|---|
| 31:0 | RXRD0 | R/W | X | Receive Ready Queue 0 |

TABLE B8
WAN_rxbdq1

| Bit field | Name | R/W | Default | Description |
|---|---|---|---|---|
| 31:0 | RXRD1 | R/W | X | Receive Ready Queue 1 |

The following shows the format of rxrd0 and rxrd1. Reserved bits are thrown away by hardware when writing to Buffer Manager. Software can interpret other bits any way it wants. RxRd0[19:18] is hardwired to 2'b11. Buffer Manager FIFO does not contain these 2 bits.

TABLE B9
Rxbdq0/1 mapping

| | | | | | | | | | | | | | | | |
|---|---|---|---|---|---|---|---|---|---|---|---|---|---|---|---|
| Word | 15 | 14 | 13 | 12 | 11 | 10 | 9 | 8 | 7 | 6 | 5 | 4 | 3 | 2 | 1 0 |

| | | | | | |
|---|---|---|---|---|---|
| Rxbdq0 | Virtual Channel | OAM | status | 2'b11 | Type |
| [31:16] | | | | | |

| Rxbdq0 | Data Length (total in all data buffers) | |
|---|---|---|
| [15:0] | | |
| Rxbdq1 | Data buffer base address offset | Data Pointer [15:9] |
| [31:16] | | |
| Rxbdq1 | Data Pointer [8:0] | 7b'0000000 |
| [15:0] | | |

TABLE B10
WAN_txbdq0

| Bit field | Name | R/W | Default | Description |
|---|---|---|---|---|
| 31:0 | TXRD0 | R | X | Transmit Ready Queue 0 |

TABLE B11
WAN_txbdq1

| Bit field | Name | R/W | Default | Description |
|---|---|---|---|---|
| 31:0 | TXRD1 | R | X | Transmit Read Queue 1 |

The following shows the format of txrd0 and txrd1. Some bits are hardwired to 1 or 0. Software can interpret other bits any way it wants. Note that Txbdq0[19:18] is contained in Buffer Manager FIFO. Txbdq0[21:20] is not contained in buffer manager FIFO. For the Final BD, software can interpret the bit fields any way it wants. The reserved bits, data buffer address offset and Txbdq1[6:0] will not be inside the buffer manager FIFO.

TABLE B12
Txbdq0/1 mapping

| | | | | | | | | | | | | | | | |
|---|---|---|---|---|---|---|---|---|---|---|---|---|---|---|---|
| Word | 15 | 14 | 13 | 12 | 11 | 10 | 9 | 8 | 7 | 6 | 5 | 4 | 3 | 2 | 1 0 |

| | | | | | | |
|---|---|---|---|---|---|---|
| Txbdq0 | Virtual Channel | OAM | status | Reserved | Identifier | Type |
| [31:16] | | | | | | |

| Txbdq0 | Data Length (total in all data buffers) | |
|---|---|---|
| [15:09 | | |
| Txbdq1 | Data buffer base address offset | Data Pointer [15:9] |
| [31:16] | | |
| Txbdq1 | Data Pointer [8:0] | 7'b0000000 |
| [15:0] | | |

TABLE B13
WAN_wrfrq

| Bit field | Name | R/W | Default | Description |
|---|---|---|---|---|
| 117:16 | TX_FREE_ID | R/W | X | Transmit Free queue ID |
| 15:0 | TX_RTN_PTR | R/W | X | Transmit Free queue |
| | | | | pointer |

1. In a communication system, a buffer management system for managing communication packets received from multiple I/O ports, said system comprising:
on-chip memory for storing at least a free data pointer and a buffer descriptor;
the free data pointer pointing to a data buffer allocated in external memory;
the buffer descriptor including at least a data pointer pointing to a data buffer configured to store one or a portion of the communication packet;
the on-chip memory having a maximum threshold such that if the number of buffer descriptors stored in the on-chip memory reaches the maximum threshold one or more buffer descriptors stored in on-chip memory are transferred to an external memory.

2. The buffer management system of claim 1, wherein:
when one or a portion of a communication packet is received, a free data pointer is removed from the on-chip memory; said one or a portion of the communication packet is stored in a data buffer pointed to by the free data pointer; a buffer descriptor is generated including the free data pointer;
and the buffer descriptor is stored in the on-chip memory.

3. The buffer management system of claim 2, wherein:
one or more free data pointers are stored in external memory; and
the on-chip memory has a minimum threshold for the number of free data pointers stored in the on-chip memory such that if the minimum threshold is met one or more free data pointers are transferred from external memory to on-chip memory.

4. The buffer management system of claim 2, further comprising a direct memory access controller for transferring buffer descriptors and data pointers between on-chip memory and the external memory.

5. The buffer management system of claim 2, wherein the on-chip memory includes a read free queue wherein said one or more free data pointers are stored.

6. The buffer management system of claim 5, wherein the on-chip memory further includes a receive ready queue wherein one or more buffer descriptors are stored.

7. The buffer management system of claim 6, wherein the on-chip memory further includes a transmit ready queue associated with an I/O port, wherein one or more buffer descriptors generated for a communication packet destined for the I/O port are transferred from the receive ready queue to the transmit ready queue for the I/O port.

8. The buffer management system of claim 7, wherein the on-chip memory further includes a write free queue for storage of a freed data pointer after the communication packet associated with that data pointer is transmitted.

9. The buffer management system of claim 7, including a plurality of transmit ready queues associated with a plurality of I/O ports, wherein transmission priority of communication packets is programmable based on the priority assigned to de-queuing buffer descriptors stored in the transmit ready queues.

10. The buffer management system of claim 2, wherein the on-chip memory comprises a receive ready queue for storing one or more buffer descriptors, said receive ready queue including a write FIFO and a read FIFO; wherein:
newly generated buffer descriptors for received communication packets are written to the write FIFO;
buffer descriptors written to the write FIFO are moved to the read FIFO, if the read FIFO is below a maximum threshold level; otherwise buffer descriptors written to the write FIFO are transferred to external memory;
buffer descriptors transferred to external memory are moved to the read FIFO if the read FIFO is below a maximum threshold level.

11. A method for receiving communication packets in a communication system using a buffer management system, said method comprising:
removing a data pointer from an on-chip read free queue, the read free queue having a minimum threshold, the data pointer pointing to a data buffer allocated in external memory for storing one or a portion of a communication packet;
storing in the data buffer one or a portion of a communication packet received by an I/O port;
generating a buffer descriptor including at least the data pointer;
storing the buffer descriptor in an on-chip receive ready queue;
wherein the receive ready queue has a maximum threshold such that if the maximum threshold is reached one or more buffer descriptors stored in the receive ready queue are transferred to external memory.

12. The method of claim 11 wherein the buffer descriptor is generated if end of a communication packet is detected.

13. The method of claim 11 wherein the buffer descriptor is generated if the data buffer is full.

14. The method of claim 11 further comprising:
if the receive ready queue is not empty then a processor reading a buffer descriptor from the receive ready queue.

15. The method of claim 12 further comprising:
if the receive ready queue reaches a minimum threshold then transferring one or more buffer descriptors, if any, from the external memory to the receive ready queue.

16. The method of claim 14 further comprising:
the processor processing one or more descriptor fields in the buffer descriptor.

17. The method of claim 16 wherein one of said one or more descriptor fields is a length field indicating the length of data stored in the data buffer associated with the buffer descriptor.

18. The method of claim 16 wherein one of said one or more descriptor fields is a status field indicating whether the data stored in the data buffer associated with the buffer descriptor is error free.

19. The method of claim 16 wherein one of said one or more descriptor fields is a type field indicating whether the buffer descriptor is associated with a data buffer storing the beginning, middle, or end of a communication packet.

20. The method of claim 16 wherein one of said one or more descriptor fields is a destination field indicating the destination of one or portion of a communication packet stored in the data buffer associated with the buffer descriptor.

21. The method of claim 16 further comprising:
the processor determining the destination of transmission of the communication packet associated with the buffer descriptor.

22. The method of claim 21 further comprising:
if the communication packet is to be transmitted to another I/O port other than the I/O port it was received then copying the buffer descriptor to an on-chip transfer ready queue associated with the destination I/O port.

23. The method of claim 21 further comprising:
if the communication packet is to be transmitted to another I/O port other than the I/O port it was received then returning the data pointer associated with the buffer descriptor to an on-chip write free queue having a maximum threshold.

24. The method of claim 23 further comprising:
if the write free queue has reached its maximum threshold then transferring free data pointers to external memory.

25. The method of claim 24 further comprising:
if the read free queue has reached its minimum threshold then transferring free data pointers in the external memory, if any, to the read free queue.

26. The method of claim 25 further comprising:
the destination I/O port reading a BD from the transfer ready queue if the transfer ready queue is not empty.

27. The method of claim 26 further comprising:
the destination I/O port transmitting the communication packet associated with the BD to a destination node based on destination information stored in the BD.

28. The method of claim 11 wherein the receive ready queue includes a write FIFO and a read FIFO, the storing step comprising:
writing the generated buffer descriptor to the write FIFO;
if the read FIFO is below a maximum threshold level then moving the buffer descriptor in the write FIFO to the read FIFO.

29. The method of claim 28 further comprising:
if the read FIFO's level is above a maximum threshold then transferring the buffer descriptor in the write FIFO to the external memory.

30. The method of claim 29 further comprising:
moving the buffer descriptors in the external memory to the read FIFO if the read FIFO falls below the maximum threshold.

31. A method for managing communication packets using a buffer management system, said method comprising:
removing a data pointer from an on-chip read free queue, the read free queue having a minimum threshold, the data pointer pointing to a data buffer allocated in external memory for storing one or a portion of a communication packet;
storing in the data buffer one or a portion of a communication packet constructed by a software application;
generating a buffer descriptor including at least the data pointer;
storing the buffer descriptor in an on-chip receive ready queue;
wherein the receive ready queue has a maximum threshold such that if the maximum threshold is reached one or more buffer descriptors stored in the receive ready queue are transferred to external memory.

32. The method of claim 31 wherein the buffer descriptor is generated if end of a communication packet is detected.

33. The method of claim 31 wherein the buffer descriptor is generated if the data buffer is full.

34. The method of claim 31 further comprising:
if the receive ready queue is not empty then a processor reading a buffer descriptor from the receive ready queue.

35. The method of claim 32 further comprising:
if the receive ready queue reaches a minimum threshold then transferring one or more buffer descriptors, if any, from the external memory to the receive ready queue.

36. The method of claim 34 further comprising:
the processor processing one or more descriptor fields in the buffer descriptor.

37. The method of claim 36 wherein one of said one or more descriptor fields is a destination field indicating a destination address for one or portion of a communication packet stored in the data buffer associated with the buffer descriptor.

38. The method of claim 37 further comprising:
transferring the buffer descriptor to an on-chip transmit ready queue for an I/O port associated with the destination address.

39. The method of claim 38 further comprising:
I/O port reading the buffer descriptor from on-chip transmit ready queue.

40. The method of claim 39 further comprising:
I/O port returning the data pointer associated with the buffer descriptor to an on-chip write free queue.

41. A method for managing interleaved communication streams in a communication system comprising:
generating a buffer descriptor having type and status data; said buffer descriptors associated with one or a portion of a communication packet stored in a data buffer allocated in an external memory; the type data indicating whether the buffer descriptor is associated with a data buffer that stores beginning, middle, or end of a communication packet; the status data indicating the communication channel from which the communication packet was received;
storing the buffer descriptor in on-chip memory;
reading the buffer descriptor from on-chip memory;
moving the buffer descriptor from on-chip memory to a buffer in external memory associated with the communication channel identified by the status data;
examining the type data for the buffer descriptor; and
if the type data indicates that the buffer descriptor is associated with a data buffer that stores the end of a communication packet then notifying a higher layer application that a communication packet is received.

42. In a communication system, a buffer management system for managing communication packets received from multiple I/O ports, said system comprising:
a first memory for storing at least a free data pointer and a buffer descriptor;
the free data pointer pointing to a data buffer allocated in a second memory;
the buffer descriptor including at least a data pointer pointing to a data buffer configured to store one or a portion of the communication packet;
the first memory having a maximum threshold such that if the number of buffer descriptors stored in the first memory reaches the maximum threshold one or more buffer descriptors stored in the first memory are transferred to the second memory.

43. The system of claim 42, wherein the first memory is accessible faster than the second memory.

43. The system of claim 42 further comprising:
the first memory having a minimum threshold such that if the number of buffer descriptors stored in the first memory reaches the minimum threshold one or more buffer descriptors stored in the second memory are transferred to the first memory.
